(19) United States
(12) Patent Application Publication
(10) Pub. No.: US 2026/0109298 A1
(43) Pub. Date: Apr. 23, 2026

(54) ADAPTIVE GEAR CARRYING SYSTEM

(71) Applicant: Scout Motors Inc., Tysons, VA (US)

(72) Inventors: Zachary Whitaker, Franklin, MI (US); Dwayne Jackson, Oakland Township, MI (US); Dean Bakker, Beverly Hills, MI (US)

(21) Appl. No.: 18/923,477

(22) Filed: Oct. 22, 2024

Related U.S. Application Data
(63) Continuation of application No. 18/923,371, filed on Oct. 22, 2024.

(51) Int. Cl. B60R 5/00

(52) U.S. Cl. CPC B60R 5/003

(57) ABSTRACT

An adaptive carry system may include a gear rack frame defining perimeter apertures, central apertures, a first locking assembly aperture, and a second locking assembly aperture. An adaptive carry system may include a first damper coupled to the first locking assembly aperture. An adaptive carry system may include a second damper coupled to the second locking assembly aperture. An adaptive carry system may include a first locking pin coupled to the first damper and movable between a first locked position and a first unlocked position. An adaptive carry system may include a second locking pin coupled to the second damper and movable between a second locked position and a second unlocked position.

### CROSS REFERENCE TO RELATED APPLICATION

This application is a continuation of U.S. patent application Ser. No. 18/923371, filed on Oct. 22, 2024, the entire contents of which are incorporated by reference herein.

### BACKGROUND

This disclosure relates to storage. More specifically, the disclosure relates to gear storage in vehicles.

### SUMMARY

In some aspects, the techniques described herein relate to an adaptive carry system including: a gear rack including: a gear rack frame defining perimeter apertures, central apertures, a first locking assembly aperture, and a second locking assembly aperture; a first damper coupled to the first locking assembly aperture; a second damper coupled to the second locking assembly aperture; a first locking pin coupled to the first damper and movable between a first locked position and a first unlocked position; and a second locking pin coupled to the second damper and movable between a second locked position and a second unlocked position.

In some aspects, the techniques described herein relate to an adaptive carry system, wherein the gear rack frame defines an octagonal perimeter.

In some aspects, the techniques described herein relate to an adaptive carry system, wherein the perimeter apertures correspond in shape to a perimeter of the gear rack frame.

In some aspects, the techniques described herein relate to an adaptive carry system, wherein the gear rack frame further defines a clasp rim.

In some aspects, the techniques described herein relate to an adaptive carry system, wherein the gear rack is configured to be fastened to a vehicle surface via the first locking pin and the second locking pin.

In some aspects, the techniques described herein relate to an adaptive carry system, wherein the gear rack frame defines a dished cavity interior of the perimeter apertures.

In some aspects, the techniques described herein relate to an adaptive carry system, wherein the first damper and the second damper extend into the dished cavity.

In some aspects, the techniques described herein relate to an adaptive carry system, wherein the central apertures extend along a central plane of the gear rack frame, wherein the first locking pin and the second locking pin are arranged in the central plane, and wherein the first damper and the second damper extend in the central plane.

In some aspects, the techniques described herein relate to an adaptive carry system, wherein the gear rack is configured to be mounted to: a rear side of a passenger seat, within a vehicle cargo area, a bottom side of a passenger seat, within a frunk, or to a storage wall.

In some aspects, the techniques described herein relate to an adaptive carry system, further including at least one of: a first accessory connected to the gear rack and including a first accessory aperture sized to receive the first locking pin and a second accessory aperture sized to receive the second locking pin to secure the first accessory to the gear rack; a second accessory connected to the gear rack and including accessory support projections sized to be received within the perimeter apertures of the gear rack frame; a third accessory connected to the gear rack and including accessory clips sized to engage the perimeter apertures of the gear rack frame to secure the third accessory to the gear rack; a fourth accessory connected to the gear rack and including a bag; or a fifth accessory connected to the gear rack and including an elastic strap.

In some aspects, the techniques described herein relate to a vehicle including: a vehicle surface; and a gear rack removably coupled to the vehicle surface and including: a gear rack frame defining perimeter apertures, central apertures, a first locking assembly aperture, and a second locking assembly aperture; a first locking pin coupled to the first locking assembly aperture and movable between a first locked position and a first unlocked position; and a second locking pin coupled to the second locking assembly aperture and movable between a second locked position and a second unlocked position.

In some aspects, the techniques described herein relate to a vehicle, wherein the first locking pin is directly coupled to the vehicle surface, and wherein the second locking pin is directly coupled to the vehicle surface.

In some aspects, the techniques described herein relate to a vehicle, wherein the first locking pin rotates between the first locked position and the first unlocked position, and wherein the second locking pin rotates between the second locked position and the second unlocked position.

In some aspects, the techniques described herein relate to a vehicle, wherein the vehicle surface is a first vehicle surface, further including a second vehicle surface remote from the first vehicle surface, wherein the gear rack is removably coupled to the second vehicle surface.

In some aspects, the techniques described herein relate to a vehicle, wherein the vehicle surface includes: a rear side of a passenger seat, a vehicle cargo area, a bottom side of a passenger seat, or a frunk.

In some aspects, the techniques described herein relate to a vehicle, wherein the gear rack frame further defines a clasp rim.

In some aspects, the techniques described herein relate to a vehicle, wherein the gear rack further includes: a first damper coupled to the first locking assembly aperture and positioned between the first locking assembly aperture and the first locking pin; and a second damper coupled to the second locking assembly aperture and positioned between the second locking assembly aperture and the second locking pin.

In some aspects, the techniques described herein relate to a vehicle including: a first gear rack coupled to a frunk wall, the first gear rack including: a first gear rack frame; a first locking pin coupled to the first gear rack frame and movable between a first locked position and a first unlocked position; and a second locking pin coupled to the first gear rack frame and movable between a second locked position and a second unlocked position, wherein the first gear rack frame is configured to support an accessory; and a second gear rack coupled to a rear cargo area wall, the second gear rack including: a second gear rack frame; a third locking pin coupled to the second gear rack frame and movable between a third locked position and a third unlocked position; and a fourth locking pin coupled to the second gear rack frame and movable between a fourth locked position and a fourth unlocked position, wherein the second gear rack frame is configured to support the accessory.

In some aspects, the techniques described herein relate to a vehicle, wherein the first gear rack further includes a support bracket extending from the first gear rack frame and configured to support the accessory.

In some aspects, the techniques described herein relate to a vehicle, wherein the first gear rack frame and the second gear rack frame are removable from the vehicle.

This summary is illustrative only and is not intended to be in any way limiting. Other aspects, features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The device is explained in even greater detail in the following drawings. The drawings are merely exemplary and certain features may be used singularly or in combination with other features. The drawings are not necessarily drawn to scale.

FIG. 1 is a top view of a cargo area of a vehicle including four gear rails, according to some implementations.

FIG. 2 is a perspective view of the cargo area of FIG. 1 showing the gear rails and a gear rack, according to some implementations.

FIG. 3 is another perspective view of the cargo area of FIG. 1, according to some implementations.

FIG. 4 is a top view of a frunk of a vehicle including three gear rails, according to some implementations.

FIG. 5 is a perspective view of the funk of FIG. 4 including a gear rack, according to some implementations.

FIG. 6 is a perspective view of the frunk of FIG. 4 with a lid in an open position, according to some implementations.

FIG. 7 is a top view of an under seat area of a vehicle including a gear rail, according to some implementations.

FIG. 8 is a perspective view of the under seat are of FIG. 7, according to some implementations.

FIG. 9 is a perspective view of a cargo area of a vehicle including a gear rail, according to some implementations.

FIG. 10 is another perspective view of the cargo area of FIG. 9, according to some implementations.

FIG. 11 is another perspective view of the cargo area of FIG. 9, according to some implementations.

FIG. 12 is an exploded view of a gear rail, a locking pin, and an accessory, according to some implementations.

FIG. 13 is a side view of the gear rail and the locking pin of FIG. 12, according to some implementations.

FIG. 14 is another side view of the gear rail and the locking pin of FIG. 12, according to some implementations.

FIG. 15 is a sectional view of the gear rail and the locking pin of FIG. 12, according to some implementations.

FIG. 16 is a perspective view of the gear rail and the locking pin of FIG. 12, according to some implementations.

FIG. 17 is a perspective view of the gear rail and the locking pin of FIG. 12 with the locking pin removed from the gear rail, according to some implementations.

FIG. 18 is a front view of a gear rack, according to some implementations.

FIG. 19 is a sectional view of the gear rack of FIG. 18, according to some implementations.

FIG. 20 is a perspective view of the gear rack of FIG. 18 installed in a cargo area of a vehicle, according to some implementations.

FIG. 21 is a perspective view of the gear rack of FIG. 18 with a locking pin in a locked position, according to some implementations.

FIG. 22 is another perspective view of the gear rack of FIG. 18 with the locking pin in the locked position, according to some implementations.

FIG. 23 is a perspective view of the gear rack of FIG. 18 with the locking pin in an unlocked position, according to some implementations.

FIG. 24 is a section view of the gear rack of FIG. 18 with the locking pin in the locked position, according to some implementations.

FIG. 25 is a perspective view of seat back of a vehicle including a gear rack, according to some implementations.

FIG. 26 is a perspective view of an underside of a seat of a vehicle including three gear racks, according to some implementations.

FIG. 27 is a perspective view of a rear end of a vehicle including a spare wheel holder in an open position and including a gear rack, according to some implementations.

FIG. 28 is a perspective view of a luggage in a first position, according to some implementations.

FIG. 29 is a perspective view of the luggage of FIG. 28 in a second position, according to some implementations.

FIG. 30 is a perspective view of the luggage of FIG. 28 secured to a gear rail under a seat of a vehicle, according to some implementations.

FIG. 31 is another perspective view of the luggage and gear rail of FIG. 30, according to some implementations.

FIG. 32 is another perspective view of the luggage and gear rail of FIG. 30, according to some implementations.

FIG. 33 is a top view of an accessory bin, according to some implementations.

FIG. 34 is a side view of two accessory bins of FIG. 33, according to some implementations.

FIG. 35 is a perspective view of the two accessory bins of FIG. 34, according to some implementations.

FIG. 36 is a perspective view of the accessory bin of FIG. 34 in an open position, according to some implementations.

FIG. 37 is a perspective view of another accessory bin in an open position, according to some implementations.

FIG. 38 is a perspective view of accessory bins connected to gear rails in a vehicle, according to some implementations.

FIG. 39 is a perspective view of an accessory bin connected to two gear rails in a vehicle, according to some implementations.

FIG. 40 is a perspective view of accessory bins connected to gear rails in a vehicle, according to some implementations.

FIG. 41 is a perspective view of cushions attached to gear rails of a vehicle, according to some implementations.

FIG. 42 is a front view of accessory bags connected to a gear rack, according to some implementations.

FIG. 43 is a front view of an accessory bag connected to a gear rack, according to some implementations.

FIG. 44 is a front view of an accessory bag connected to a gear rack, according to some implementations.

FIG. 45 is a top view of an accessory cushion, according to some implementations.

FIG. 46 is a side view of the accessory cushion of FIG. 45 including an accessory bag and accessory straps, according to some implementations.

FIG. 47 is a side view of the accessory cushion of FIG. 45, according to some implementations.

FIG. 48 is a perspective view of three accessory cushions, according to some implementations.

FIG. 49 is a perspective view of an accessory cushion connected to gear rails of a frunk of a vehicle, according to some implementations.

FIG. 50 is a perspective view of a cargo area of a vehicle including gear rails, a gear rack, an accessory bin, and an accessory cushion, according to some implementations.

FIG. 51 is a perspective view of wall mounted gear rails and gear racks, according to some implementations.

### DETAILED DESCRIPTION

Following below are more detailed descriptions of concepts related to, and implementations of, methods, apparatuses, and systems for adaptive gear carrying. The figures illustrate exemplary implementations in detail and the present disclosure is not limited to the details or methodology set forth in the description or illustrated in the figures. The terminology used herein is for the purpose of description only and should not be regarded as limiting.

Referring to the figures generally, the various implementations disclosed herein relate to systems, apparatuses, and methods for an adaptive gear carry system. The adaptive gear carry system includes generally linearly extending gear rails and individual gear racks mounted on a vehicle (e.g., interior the vehicle or exterior the vehicle). The gear racks can also be mounted to the gear rails. Accessories can be mounted to either the gear rails or the gear racks. Some accessories are structured to be supported exclusively by the gear rails, and some accessories are structured to be supported exclusively by the gear racks. Some accessories can be mounted to either the gear rails or the gear racks. The adaptive gear carry system provides an inclusive platform where storage boxes, bags, luggage, pads, and other accessories can be stored in multiple positions through the interior and exterior of the vehicle. In some implementations, the adaptive gear carry system also includes wall mounted gear rails and gear racks that can hold accessories so that a storage accessory can be moved between storage on a wall (e.g., in a garage) and the vehicle for portable storage.

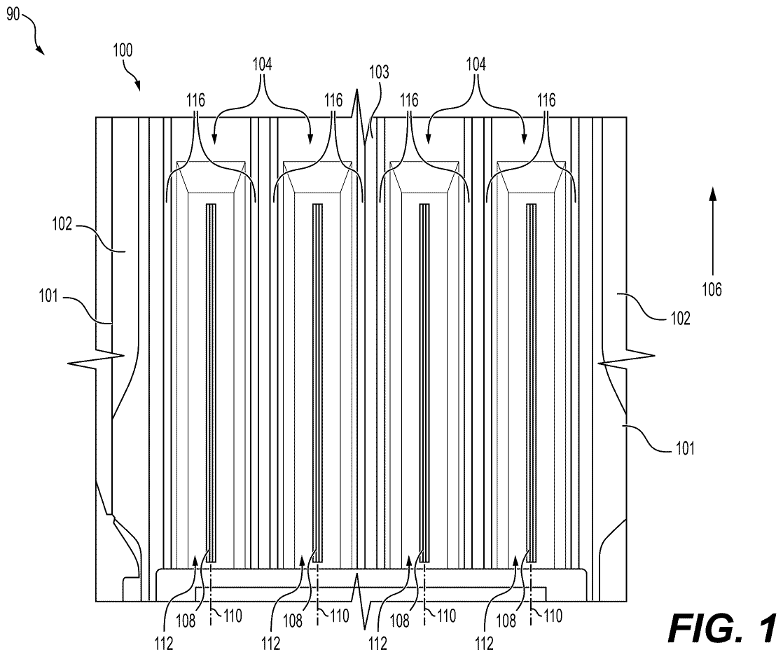

As shown in FIG. 1, a vehicle 90 includes a vehicle cargo area 100 in the form of a sport-utility-vehicle rear interior cargo area. The vehicle cargo area 100 includes vehicle surfaces in the form of walls 101, wheel wells 102, and a rear floor 103 generally bounded by the walls 101 and the wheel wells 102. In some implementations, the vehicle cargo area 100 extends from a set of rear seats to a tailgate area. In some implementations, the vehicle cargo area 100 is a truck bed, a frunk, a trunk, or another storage area.

The vehicle cargo area 100 includes gear rails 104 mounted to the rear floor 103. In the example shown, four of the gear rails 104 are mounted to the rear floor 103. In some implementations, the vehicle cargo area 100 includes more than four or less than four gear rails 104. Each of the gear rails 104 is spaced apart from an adjacent gear rail 104. In some implementations, the gear rails 104 are parallel. In some implementations, the gear rails 104 extend in a direction parallel with a forward direction 106 of the vehicle 90.

Each of the gear rails 104 includes a linearly extending track or rail in the form of a t-slot track 108 recessed into the vehicle surface (e.g., the rear floor 103) and extending along a track axis 110. A gear rail cavity 112 is bounded on two sides by support channels 116. In some implementations, the gear rail cavity 112 includes two sloped walls and a flat area sized to surround the t-slot track 108. The support channels 116 extend parallel to the track axis 110 and define a generally rectangular cross-sectional profile. The support channels 116 are spaced apart from the t-slot track 108 by the gear rail cavity 112. In some implementations, the support channels 116 are positioned on opposite sides of the t-slot track 108 relative to one another. The support channels 116 provide support to accessories (discussed below) and inhibit movement of the accessories (e.g., rotational, tipping, etc.) while installed on the gear rails 104. In some implementations, the support channels 116, the gear rail cavity 112, and the track recess 176 are formed as a housing sized to receive the t-slot track 108. In some implementations, the housing is formed from plastic.

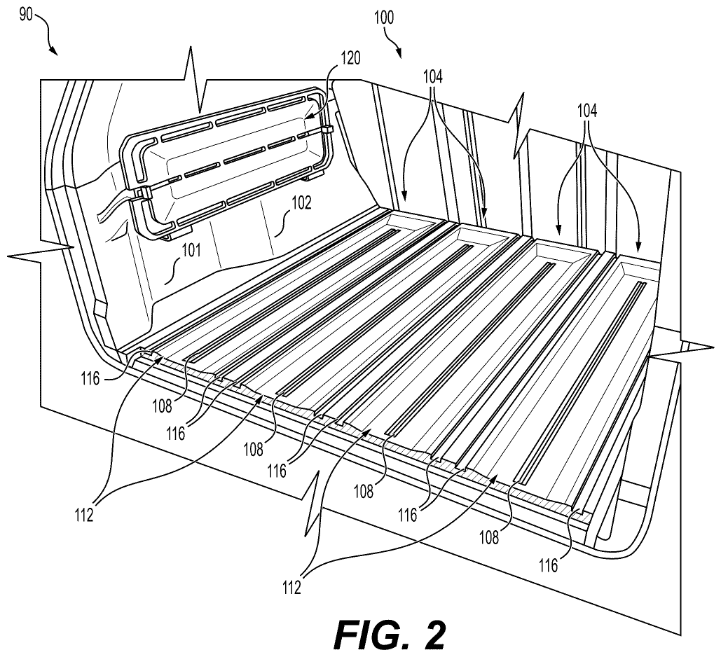

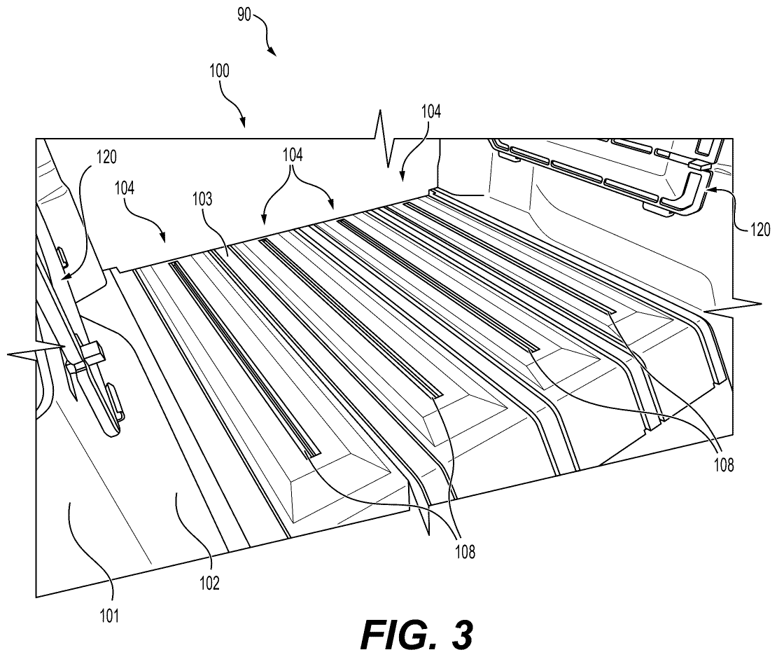

As shown in FIGS. 2 and 3, the cargo area 100 also includes two gear racks 120 mounted to the walls 101. The gear racks 120 are discussed in detail below.

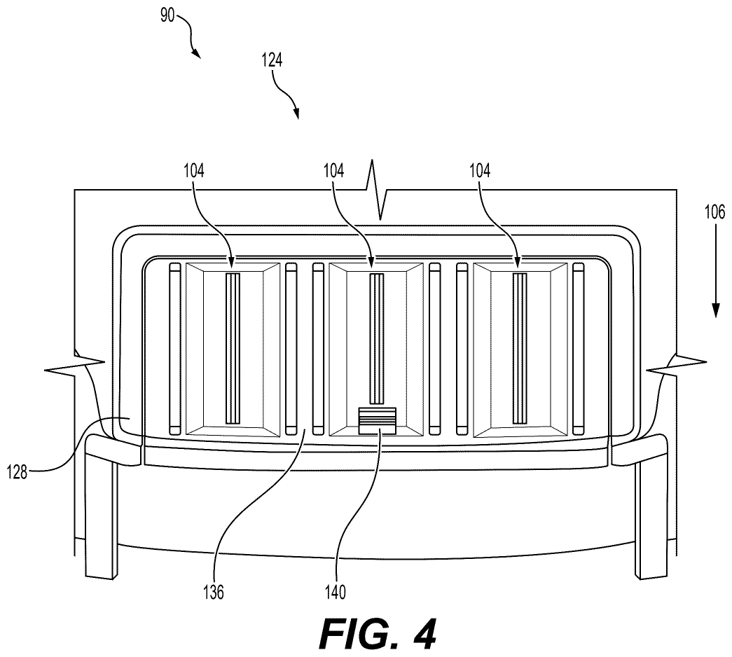

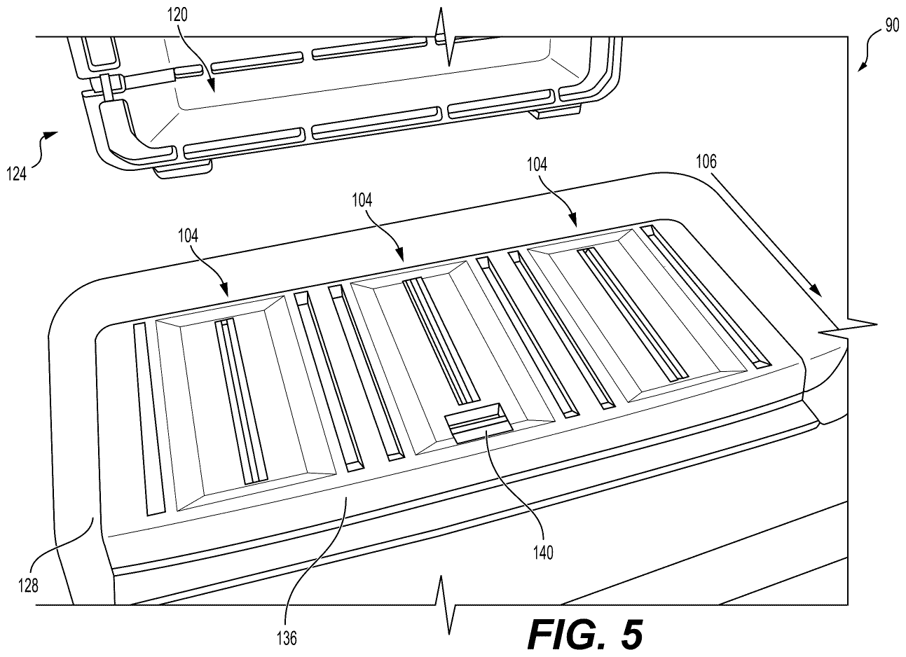

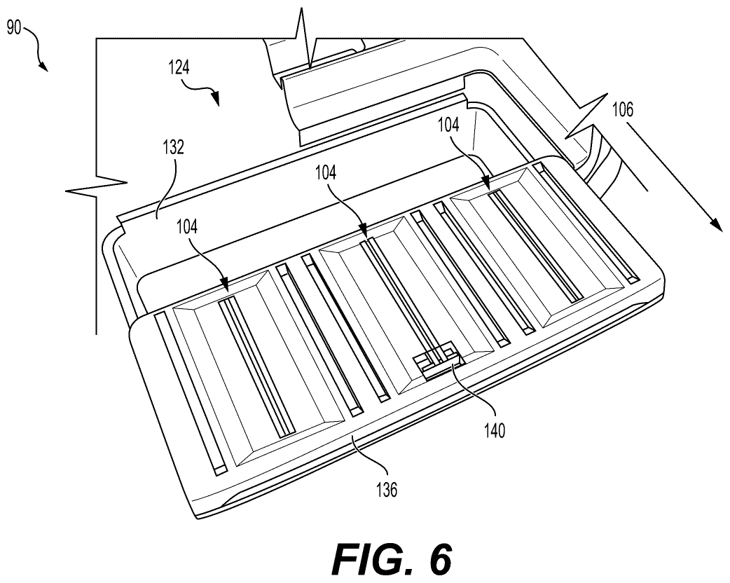

As shown in FIGS. 4-6, the vehicle 90 includes a storage area 124 in the form of a frunk. The storage area 124 includes a vehicle surface in the form of a frunk floor 128 including a recessed tub 132 (see FIG. 6), a frunk floor lid 136 selectively covering the tub 132 and movable between a closed position (see FIG. 4) and an open position (see FIG. 6), and a latch 140 that selectively inhibits movement of the frunk floor lid 136. In some implementations, the frunk floor lid 136 slides between the closed position and the open position (e.g., on rails, in a channel, etc.). In some implementations, the frunk floor lid 136 rotates between the closed position and the open position (e.g., on hinges). As shown in FIG. 6, the frunk floor lid 136 can slide to the open position and provide a work surface usable as a table, a seat, a work bench, etc. The frunk floor lid 136 includes three gear rails 104 that are similar to the gear rails 104 discussed above. In some implementations, the gear rails 104 are mounted to another vehicle surface of the storage area 124 (e.g., the walls). In some implementations, more than three or less than three gear rails 104 are included. In some implementations, the frunk floor lid 136 is eliminated and the vehicle surface is the frunk floor 128. In some implementations, the storage area 124 includes at least one gear rail 104 mounted to both the frunk floor 128 and another vehicle surface within the storage area 124 (e.g., a wall). In some implementations, the latch 140 locks the frunk floor lid 136 in both the open position to inhibit movement to the closed position, and locks the frunk floor lid 136 in the closed position to inhibit movement to the open position. In some implementations, the storage area 124 includes a gear rack 120 mounted to a wall of the storage area 124. In some implementations, the gear rails 104 extend in a direction parallel to a forward direction 106 of the vehicle 90.

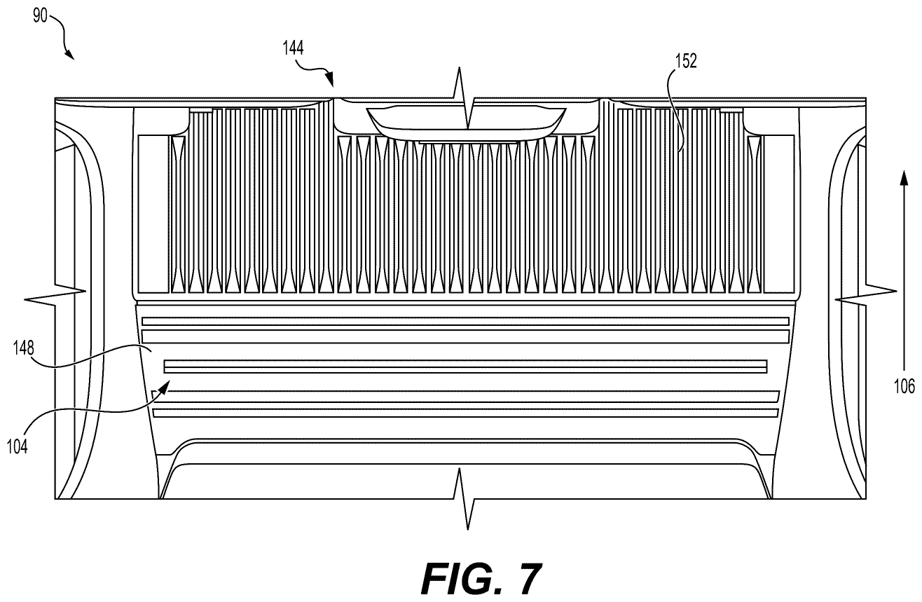

As shown in FIGS. 7 and 8, the vehicle 90 includes a storage area 144 in the form of a under seat area. In FIGS. 7 and 8 the rear seat has been removed for clarity. The storage area 144 includes cabin floor 148 positioned under neath a rear seat and a foot well 152 that supports occupant's feet while they are sitting in the rear seat. A gear rail 104 is positioned in the cabin floor 148 and the track axis 110 of the gear rail 104 is arranged oblique relative to the forward direction of the vehicle 90. In some implementations, the track axis 110 is arranged perpendicular to the forward direction of the vehicle 90. The gear rails 104 positioned within the storage area 144 allows the user to attach accessories underneath the rear seat. In some implementations, the storage area 144 is positioned underneath a front seat of the vehicle 90. In some implementations, the storage area 144 is positioned under a third row of seats. In some implementations, the storage area 144 is positioned under a single seat. In some implementations, the storage area 144 is positioned under a bench seat.

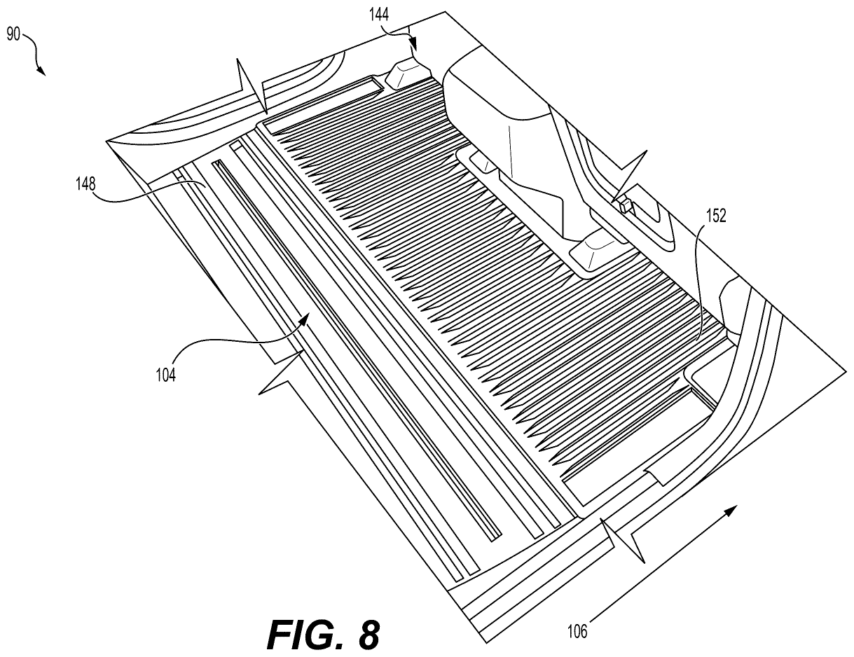

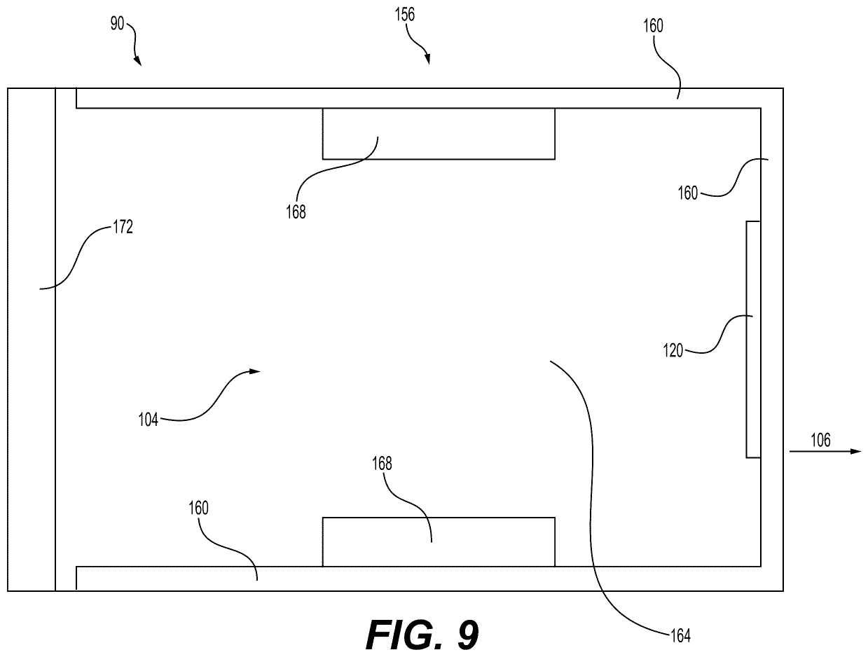

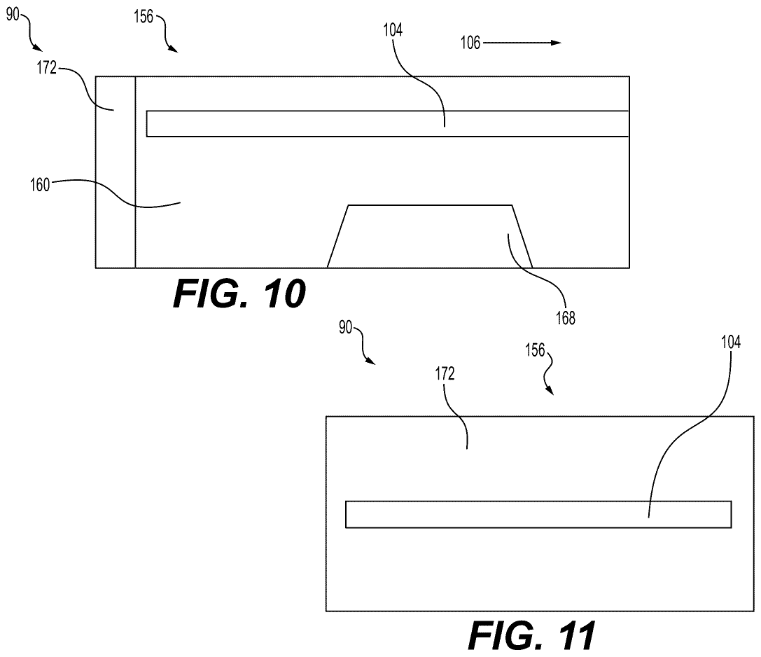

As shown in FIGS. 9-11, in some implementations, the vehicle 90 includes a storage area 156 in the form of a truck bed. The storage area 156 includes vehicle surfaces in the form of three walls 160, a bed floor 164, wheel wells 168, and a tailgate 172. In some implementations, a gear rack 120 is mounted to a front wall 160 of the storage area 156. In some implementations, a gear rail 104 is mounted to a front wall 160 of the storage area 156. As shown in FIG. 10, a side wall 160 includes a gear rail 104. As shown in FIG. 11, in some implementations, the tailgate 172 includes a gear rail 104. In some implementations, one or more gear racks 120 are mounted on other walls 160 and/or the tailgate 172. In some implementations, one or more gear rails 104 are mounted on the front wall 160 and/or the other walls 160 and/or the tailgate 172.

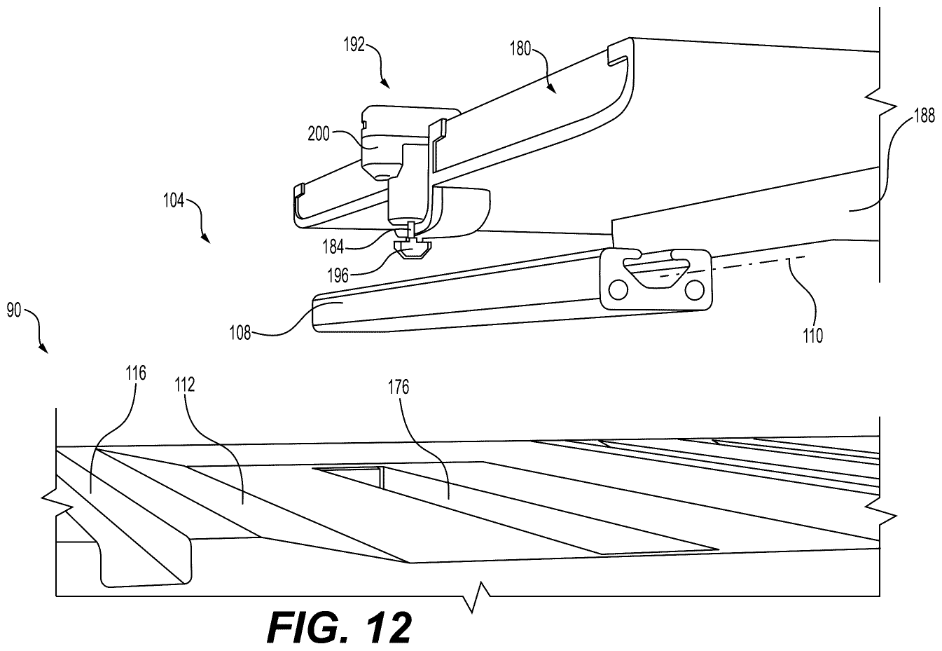

As shown in FIG. 12, each gear rail 104 includes the t-slot track 108 defining a t-slot profile. In some implementations, the t-slot track 108 defines a differently shaped engagement profile. The gear rail cavity 112 defines a track recess 176 sized to receive the t-slot track 108. The t-slot track 108 is fastened to, adhered to, or otherwise affixed into the track recess 176.

An accessory 180 is shown exploded from the gear rail 104 and includes an accessory aperture 184 arranged to be aligned with the t-slot track 108. The accessory 180 also includes an accessory projection 188 sized to be received within the support channels 116. In some implementations, the accessory 180 includes one accessory projection 188. In some implementations, the accessory 180 includes at least two accessory projections 188 sized to engage one or both of the support channels 116 of the gear rails 104. In some implementations, the accessory 180 includes two or more accessory apertures 184.

A locking pin 192 is shown engaged with the accessory aperture 184 and includes a t-nut 196 and a locking pin body 200. The t-nut 196 is sized to be received within the t-slot track 108 and the locking pin body 200 sized to engage the accessory aperture 184.

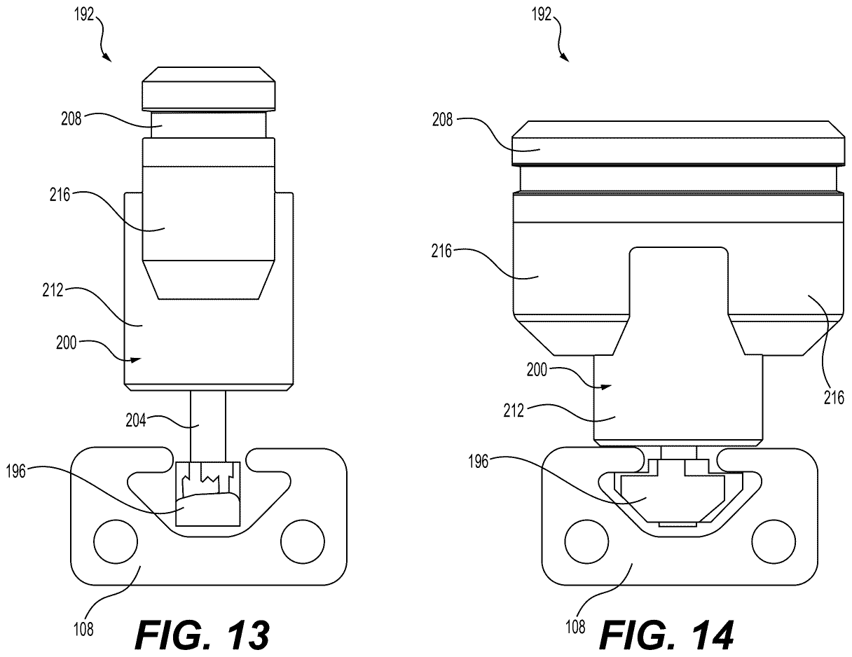

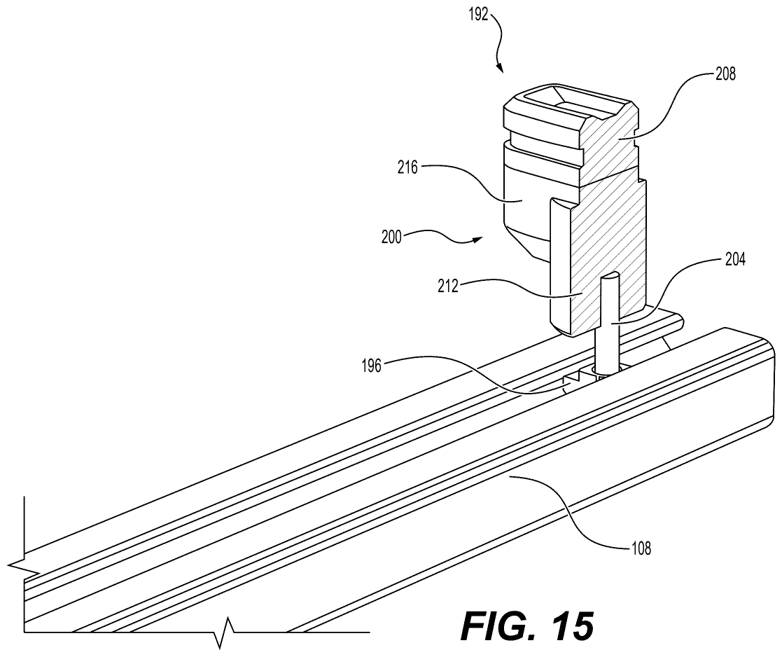

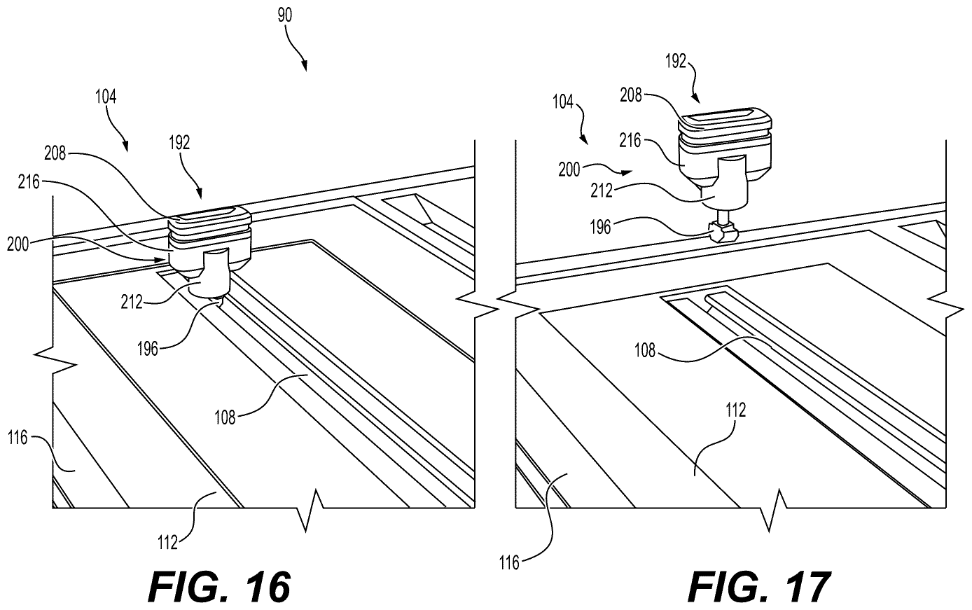

As shown in FIGS. 13-17, the locking pin 192 further includes a pin shaft 204 and a locking pin handle 208. The pin shaft 204 is coupled to the t-nut 196, and the locking pin handle 208 is rotatably coupled to the locking pin body 200. The locking pin body 200 includes a central shank 212 and two shoulders 216 extending from the central shank 212. The locking pin body 200 is shaped to engage the accessory aperture 184 of the accessory 180 and selectively secure the accessory 180 to the gear rails 104. In some implementations, the pin shaft 204 is rigidly connected to the locking pin handle 208 so that rotation of the locking pin handle 208 relative to the central shank 212 causes the pin shaft 204 and the t-nut 196 to rotate relative to the central shank 212 and translate relative to the central shank 212. In some implementations, rotation of the locking pin handle 208 moves the locking pin 192 between a disengaged position (see FIG. 13) and an engaged position (see FIG. 14). In some implementations, a quarter turn of the locking pin handle 208 relative to the central shank 212 moves the locking pin 192 between the engaged and disengaged positions. In some implementations, the t-nut 196 includes a spring loaded or cam actuated mechanism to actuate the locking pin 192 between the engaged and disengaged positions. In some implementations, (see FIG. 15) the pin shaft 204 is connected directly to the locking pin body 200 and the locking pin handle 208 is eliminated or formed together with the locking pin body 200 so that the entire locking pin 192 is rotated to move the locking pin 192 between the engaged and disengaged positions.

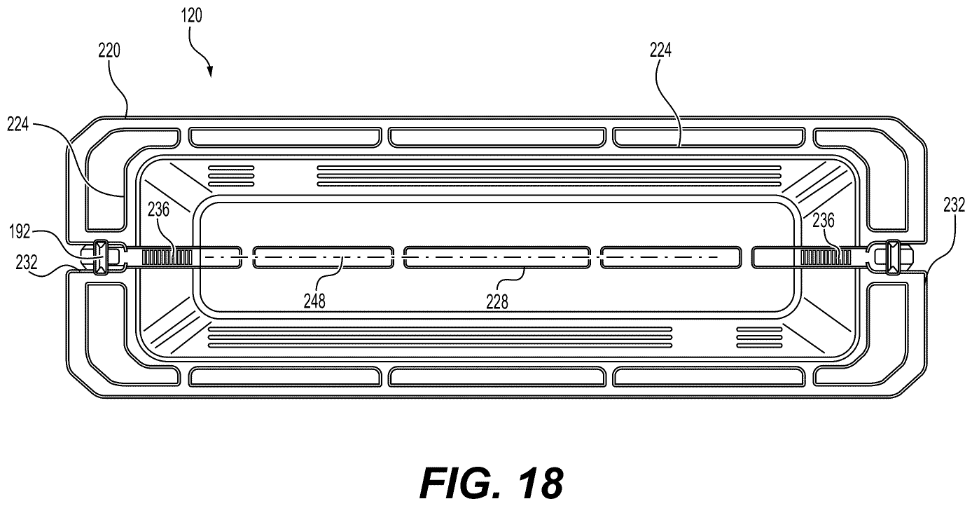

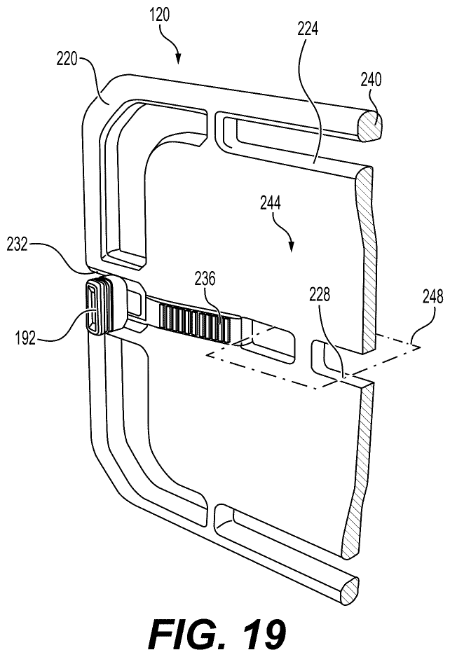

As shown in FIGS. 18 and 19, the gear rack 120 mentioned above is connectable to vehicle surfaces and/or gear rails 104 mounted to the vehicle 90. In some implementations, the gear rack 120 can be considered an accessory, and other (e.g., secondary accessories) can be mounted to the gear rack 120. In some implementations, the gear rack 120 is fastened to a vehicle surface via the first locking pin 192 and the second locking pin 192. The gear rack 120 can be dimensioned differently than shown in FIGS. 18 and 19 and multiple gear racks 120 of differing sizes can be used in the vehicle 90 simultaneously. The gear rack 120 includes a gear rack frame 220 defining perimeter apertures 224, central apertures 228, a first locking assembly aperture 232, and a second locking assembly aperture 232. The perimeter apertures 224 and the central apertures 228 can be used to engage and stabilize accessories mounted to the gear rack 120. The locking assembly apertures 232 are sized to receive locking pins 192 or locking pins that are permanently mounted to vehicle surfaces without engagement with the gear rails 104. For example, the rear cargo area 100 includes two locking pins mounted on the walls 101 is spaced to engage a gear rack 120. The gear rack 120 also includes a first damper 236 coupled to the first locking assembly aperture 232 and a second damper 236 coupled to the second locking assembly aperture 232. In some implementations, the gear rack frame 220 defines an octagonal perimeter. In some implementations, the perimeter apertures 224 correspond in shape to a perimeter of the gear rack frame 220.

The gear rack frame 220 defines a central plane 248. The central apertures 228 extend along the central plane 248 of the gear rack frame 220. When the gear rack 120 is mounted or installed on the locking pins 192, the first locking pin 192 and the second locking pin 192 are both arranged in the central plane 248. The first damper 236 and the second damper 236 both extend parallel to the central plane 248. The first damper 236 and the second damper 236 extend into the dished cavity 244.

As shown in FIG. 19, the gear rack frame 220 further defines a clasp rim 240 that is shaped to engage a clasp and allows accessories to be attached to the gear rack 120 via straps or other fasteners that use clasps. The gear rack frame 220 also defines a dished cavity 244 interior of the perimeter apertures 224. The dished cavity 244 is shaped to accommodate some accessories and can help in locating or otherwise installing the accessories onto the gear rack 120.

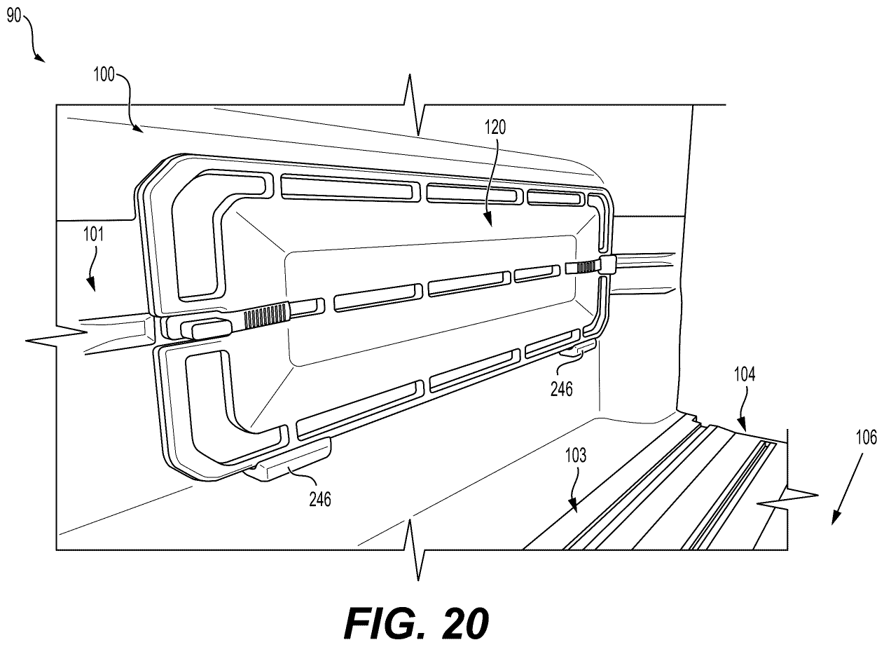

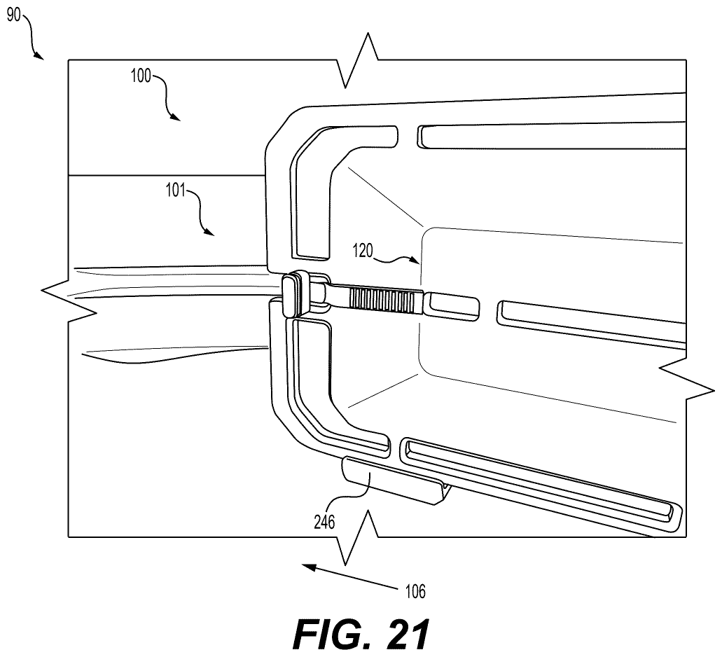

The gear rack 120 can be mounted in various areas of the vehicle 90 and on various vehicle surfaces. For example, as shown in FIGS. 20 and 21, the gear rack 120 is mounted to a wall 101 in the cargo area 100. In implementations with the gear rack 120 mounted to the wall 101, the gear rack 120 can include support brackets 246 that aid in supporting accessories. In some implementations, the support brackets 246 extend from the walls 101 and aid in supporting the gear rack 120 and maintaining the gear rack 120 in position during use.

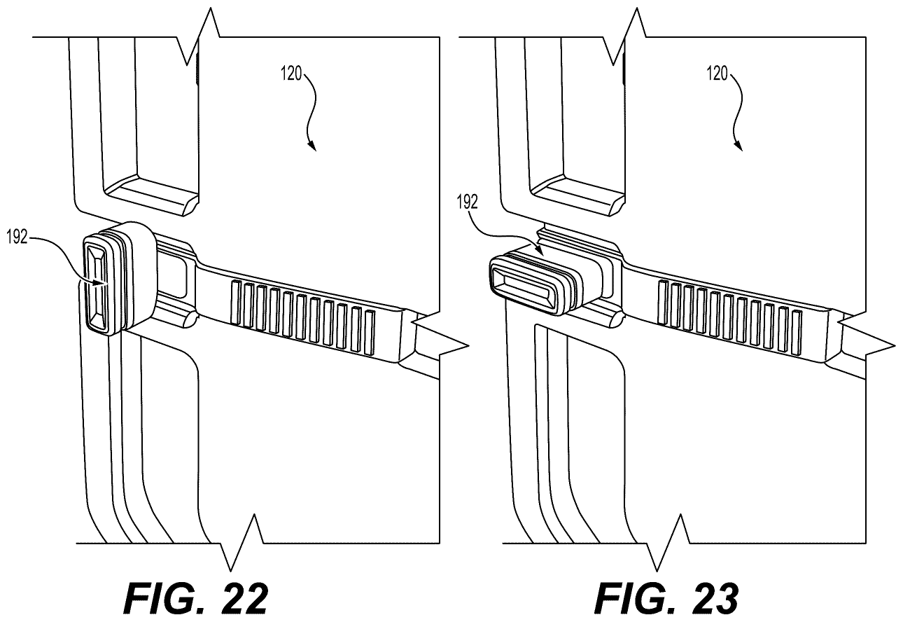

As shown in FIG. 22, the locking pin 192 can be arranged in the engaged position to inhibit removal of the gear rack 120 and to maintain the gear rack 120 in a desired position/location. As shown in FIG. 23, the locking pin 192 can be moved to the disengaged position to allow the gear rack 120 to be removed from the vehicle surface and carried away. This can allow for one gear rack 120 to be removed and another (e.g., loaded with different accessories) to be mounted in its place.

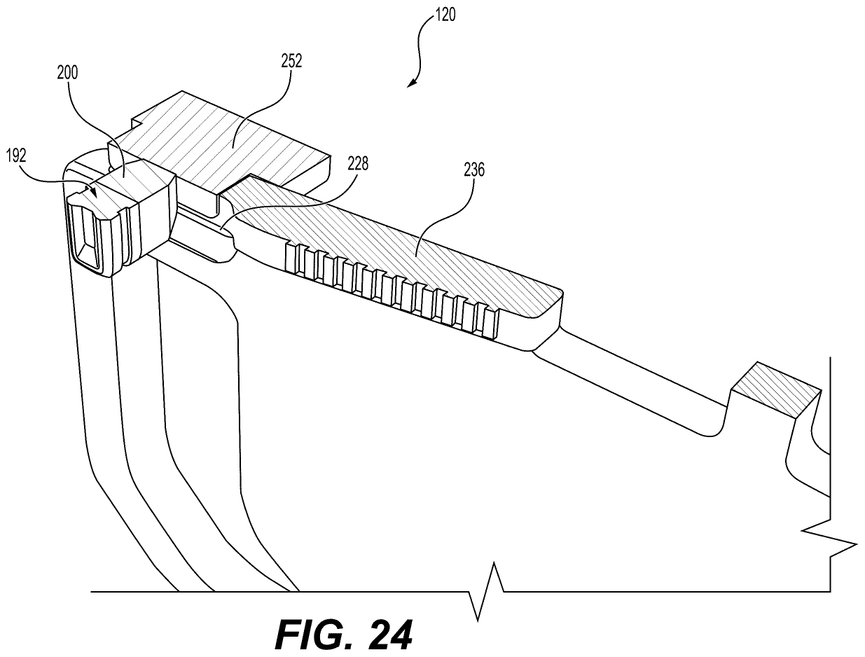

As shown in FIG. 24, the locking pin 192 is hard mounted to the vehicle 90 via a pin base 252 and the locking pin body 200 is rotatable relative to the pin base 252. The dampers 236 surround and engage the central apertures 228 so that the locking pins 192 are primarily supported by the dampers 236 to inhibit vibration during driving and use. The dampers 236 can also inhibit vibration of accessories mounted to the gear rack 120.

In some implementations, the locking pins 192 also attach to accessories to hold both the gear rack 120 and the accessory in place. In some implementations, the locking pins 192 hold only the gear rack 120 in place and other fastening structures are used to connect the accessory to the gear rack 120. In some implementations, the gear rack 120 includes locking pins 192 that connect to an accessory, and a separate set of locking pins 192 is used to connect the gear rack 120 to the vehicle surface.

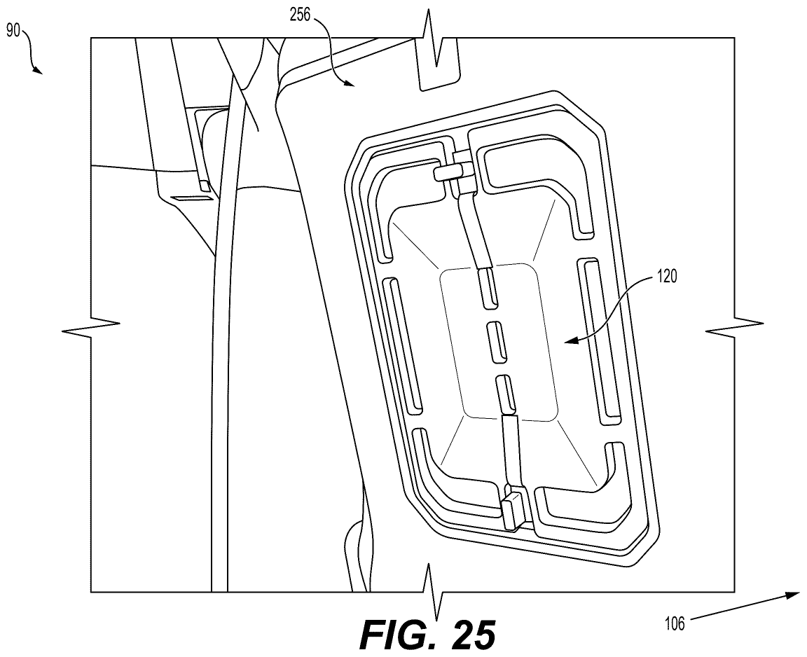

As shown in FIG. 25, a rear side of a vehicle seat 256 includes a gear rack 120. In some implementations, the gear rack 120 is removably connected to the vehicle seat 256. In some implementations, the gear rack 120 is formed as a part of the vehicle seat 256. For example, in some implementations, a back panel of the vehicle seat 256 may be formed (e.g., molded) to include a cavity or indentation having a size corresponding to the gear rack 120 such that the gear rack 120 is at least partially recessed into the seat back.

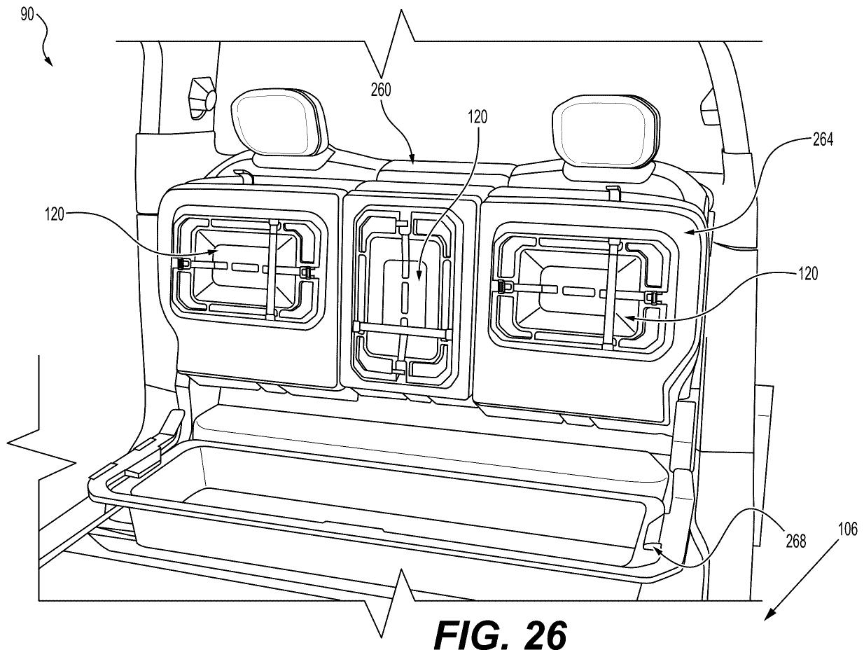

As shown in FIG. 26, a rear bench seat 260 includes a seat base 264 with a cushion for supporting a vehicle occupant and a hard plastic under surface that supports three gear racks 120. The seat base 264 is movable (e.g., pivotably) between a use position for supporting seated users, and an open position where the user can access the gear racks 120 and accessories mounted thereto. In some implementations, an under seat bin 268 can be mounted under the seat base 264. As with the seat back described above, in some implementations, the under surface of the rear bench seat 260 can be formed (e.g., molded) to include a cavity or indentation having a size corresponding to the gear racks 120 such that the gear racks 120 are at least partially recessed into said under surface.

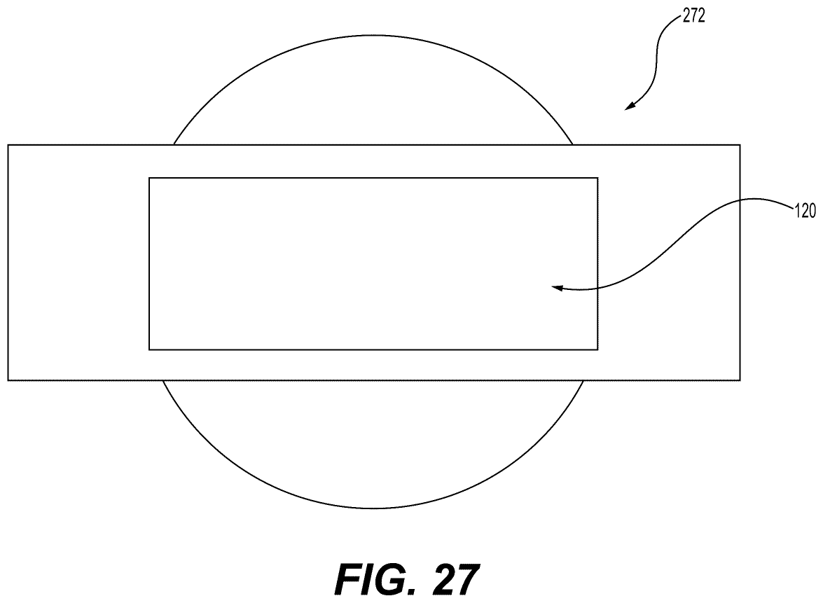

As shown in FIG. 27, a wheel carrier 272 can be mounted on a vehicle exterior. A gear rack 120 is mounted to the wheel carrier 272 to provide an accessory mounting point on the wheel carrier 272.

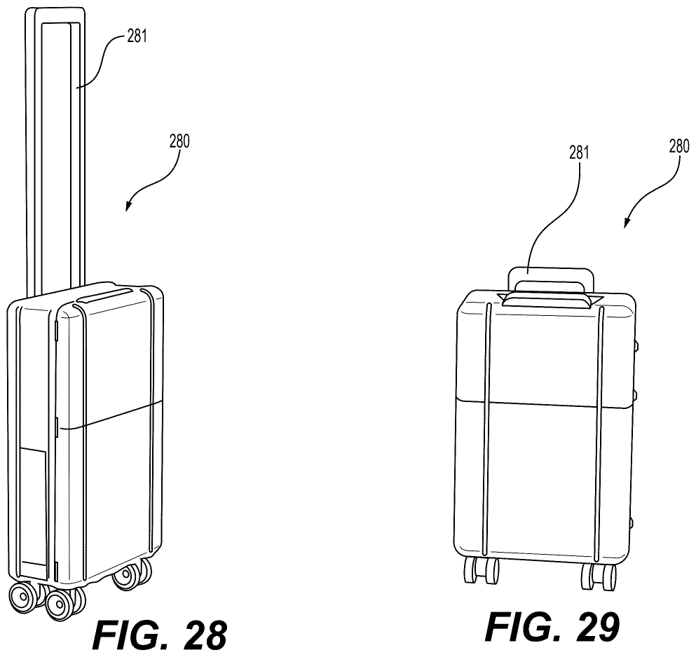

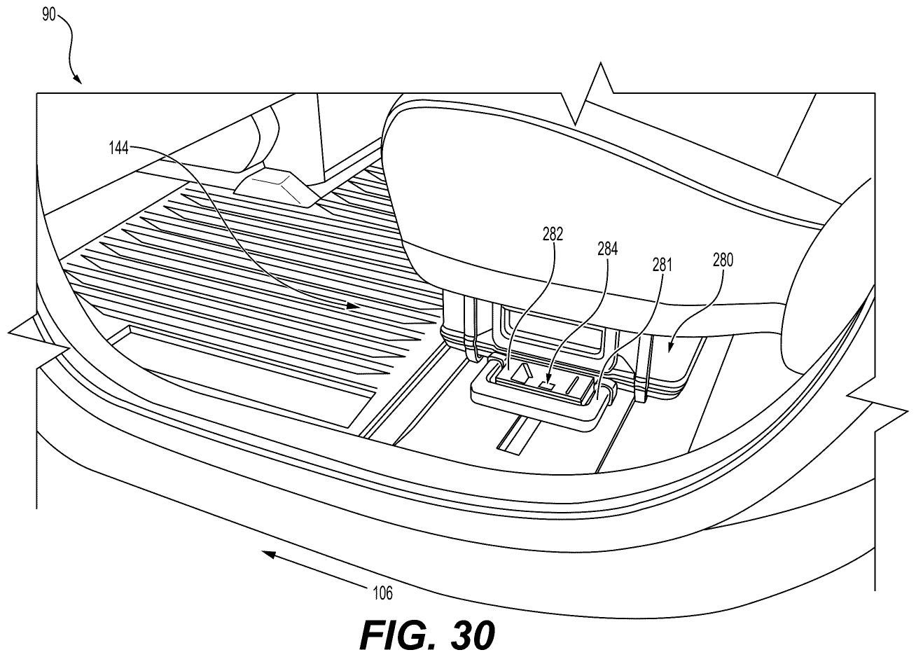

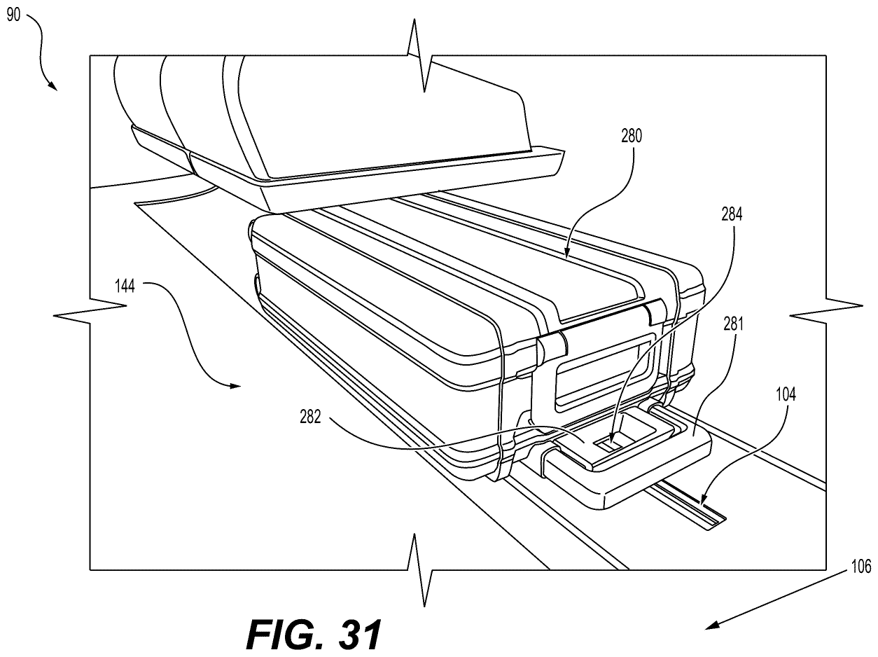

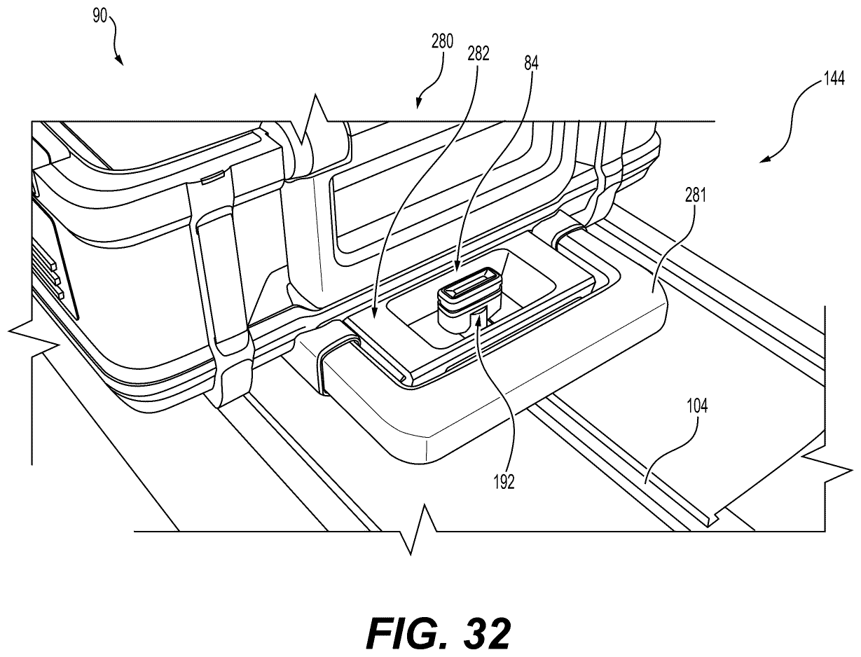

As shown in FIGS. 28-32, an accessory in the form of luggage 280 (e.g., a rollaboard) can include a handle 281 deployable between a retracted position (see FIG. 29), an extended position (see FIG. 28), and a storage position between the retracted position and the extended position (see FIG. 30). As shown in FIGS. 30-32, the luggage 280 can be secured to any of the gear rails 104 in the vehicle 90 using a mounting panel 282 that defines an accessory aperture 284 sized to receive a locking pin 192. The mounting panel 282 is sized to engage the handle 281 when the handle 281 is arranged in the storage position. In the example shown, the mounting panel 282 is sized to engage the inner periphery of an opening formed between the handle 281 and the luggage 280 when the handle 281 is arranged in the storage position. With the mounting panel 282 engaged with the handle 281, the locking pin 192 can be inserted through the accessory aperture 184 and engaged with the gear rails 104 to secure the luggage 280 in place during transport. FIGS. 30-32 show the luggage 280 stored in the storage area 144 under the seat, and other positions throughout the vehicle 90 are contemplated.

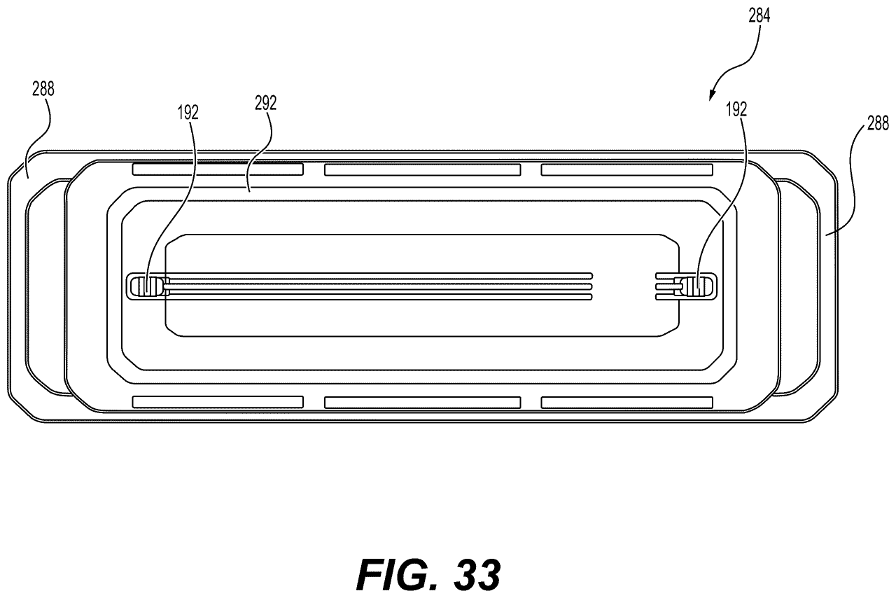

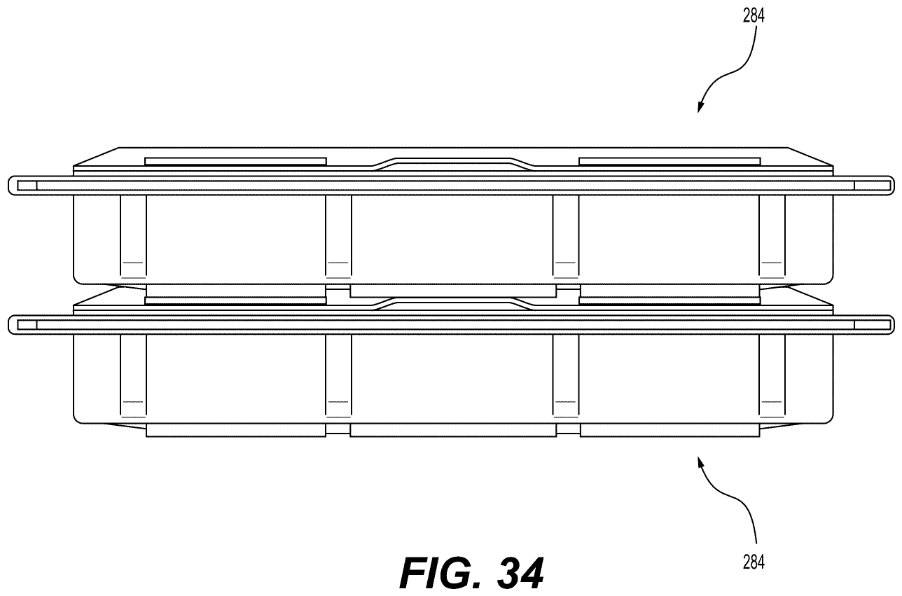

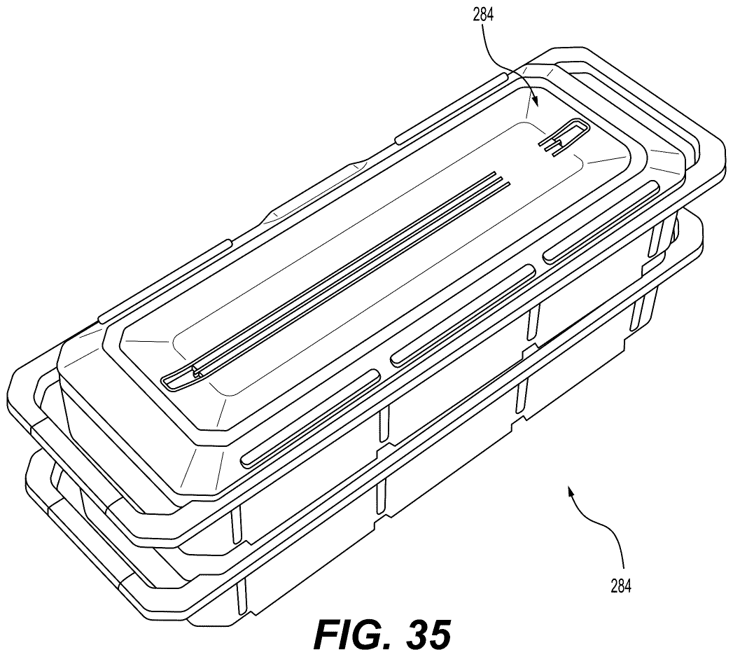

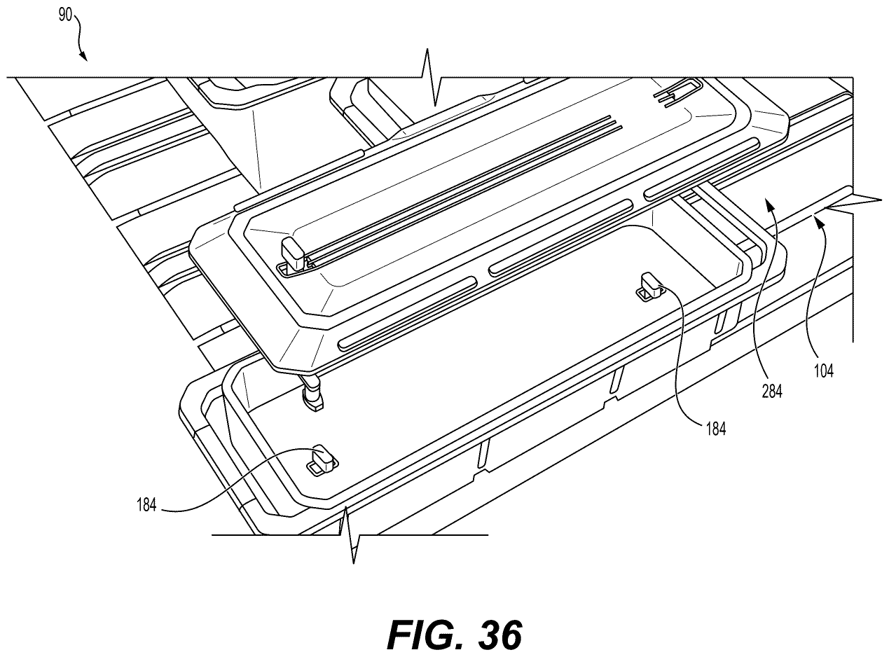

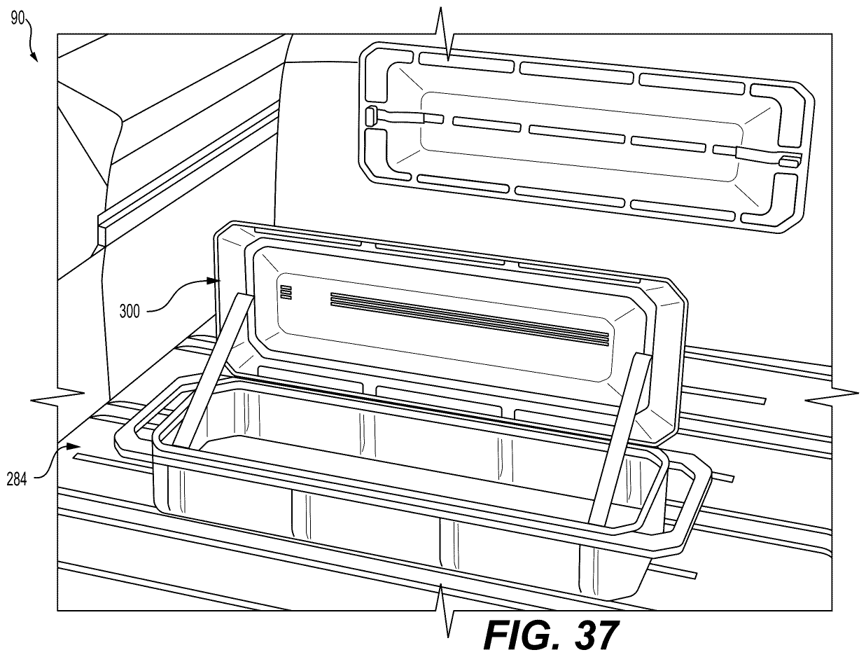

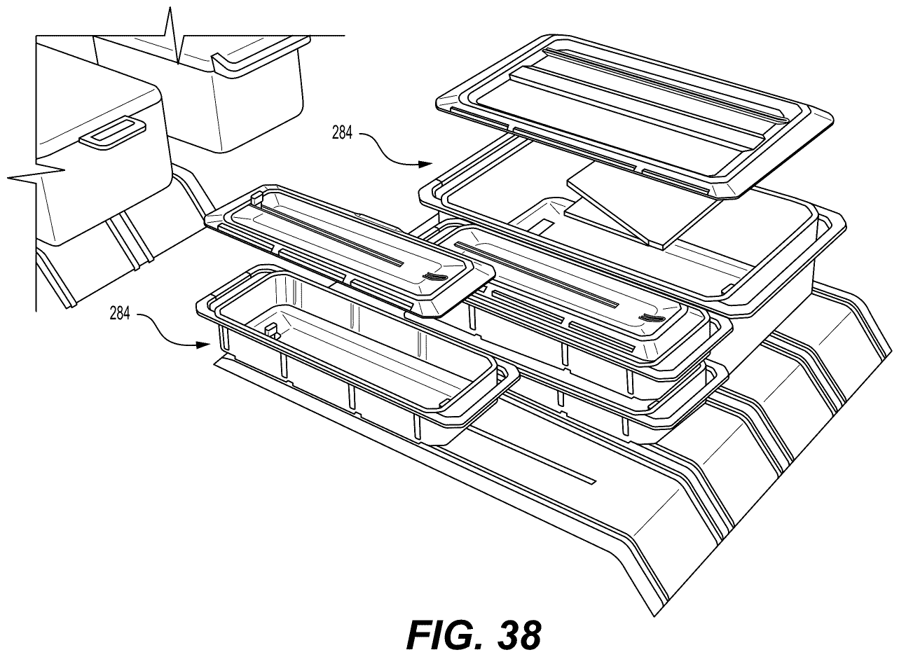

As shown in FIGS. 33-36, an accessory in the form of a bin 284 including two handles 288 and a bin lid 292. The bin lid 292 includes two locking pins 192 allowing additional accessories (e.g., more bins) to be attached to the bin lid 292. For example, two bins 284 are shown stacked in FIGS. 34 and 35. As shown in FIG. 36, each bin 284 includes accessory apertures 184 sized to receive accessory aperture 184 and allow the bin 284 to be mounted to a gear rails 104. As shown in FIG. 37, some bins 284 include a hinged lid 300. As shown in FIG. 38, the bin 284 can define various dimensions. In some implementations, the bin 284 connects to multiple gear rails 104. In some implementations, the bin 284 defines a rounded shape. In some implementations, the bin 284 defines a squared shape. As shown in FIG. 39, some bins 284 include a clear lid 304 (e.g., translucent or transparent) to provide easier inspection of an interior of the bin 284 without removing the clear lid 304.

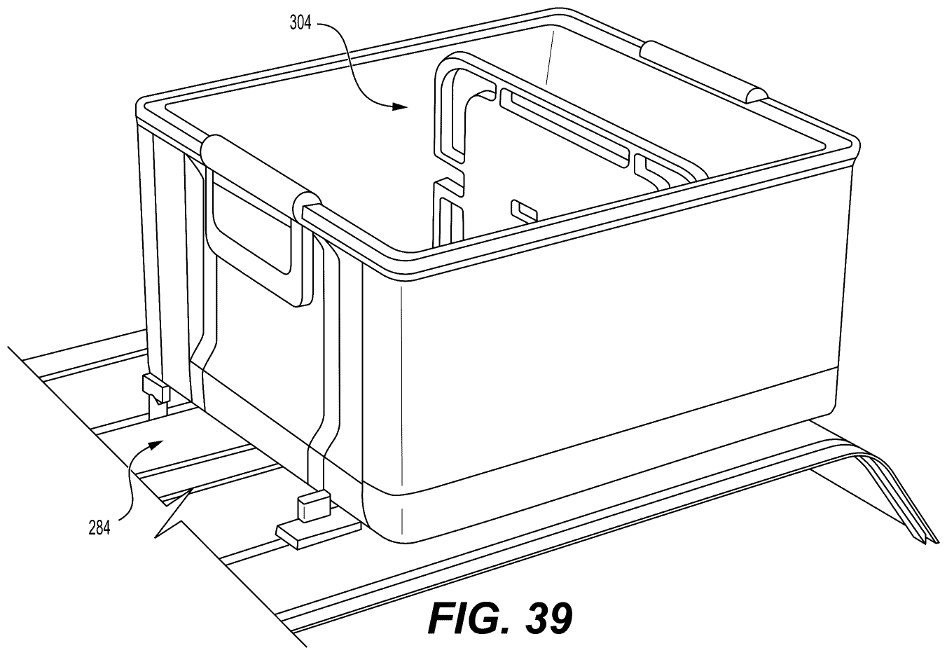

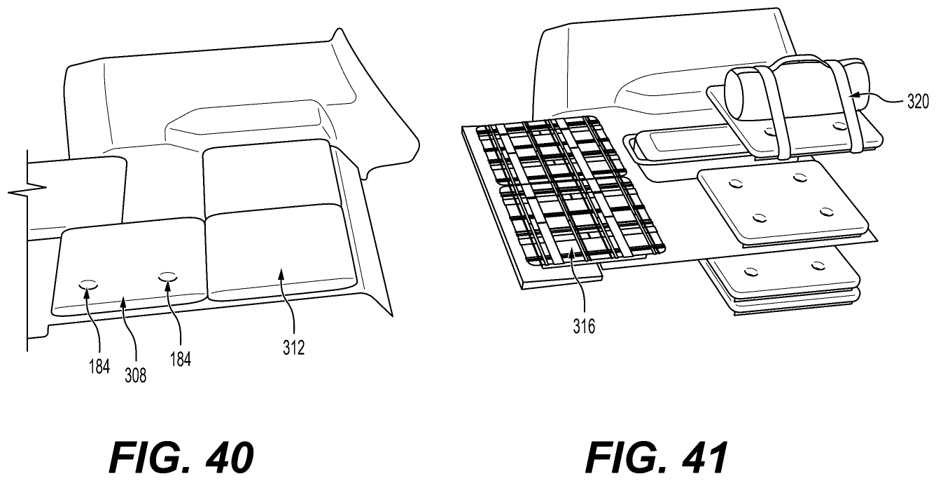

As shown in FIGS. 40 and 41, the accessory includes a cushion frame 308 defining the accessory aperture 184, and a cushion 312 coupled to the cushion frame 308. A cushion cover 316 is removably coupled to the cushion frame 308 and holds the cushion 312 in place during use. The cushion frames 308 can be attached to the gear rails 104 around the vehicle 90 to provide comfortable seating (e.g., on the frunk floor lid 136). In some implementations, tie down straps 320 extend from the cushion frame 308 and can be used to attach a blanket roll or other accessories. In some implementations, the cushion frames 308 can be engaged with the support channels 116 and not secured to the t-slot track 108 of the gear rails 104.

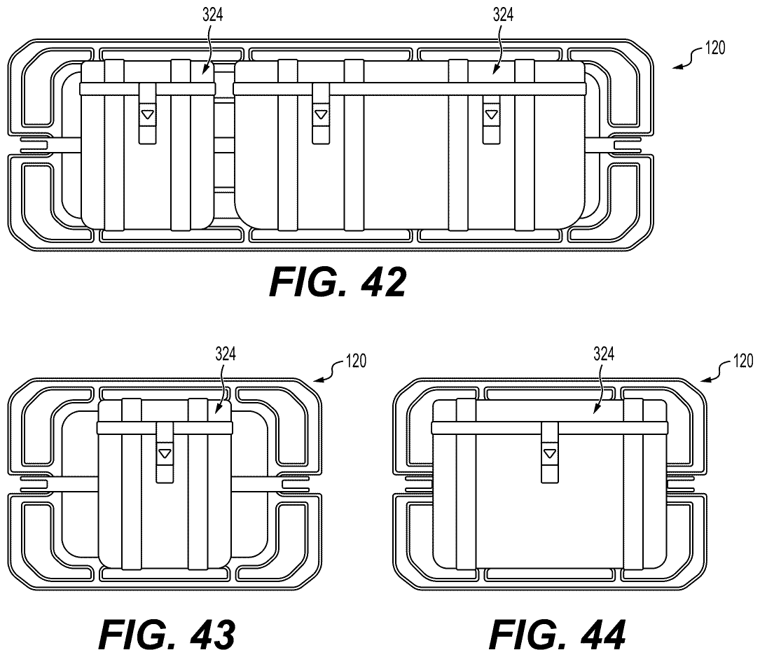

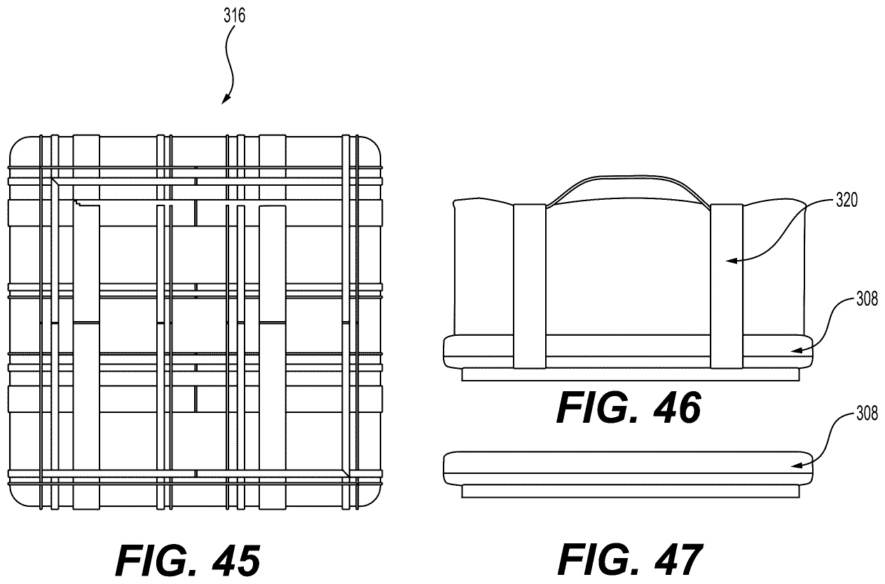

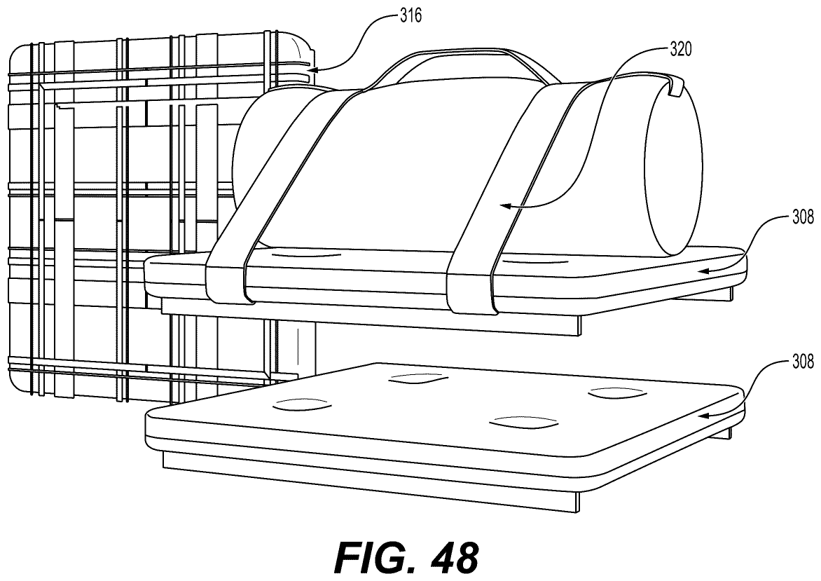

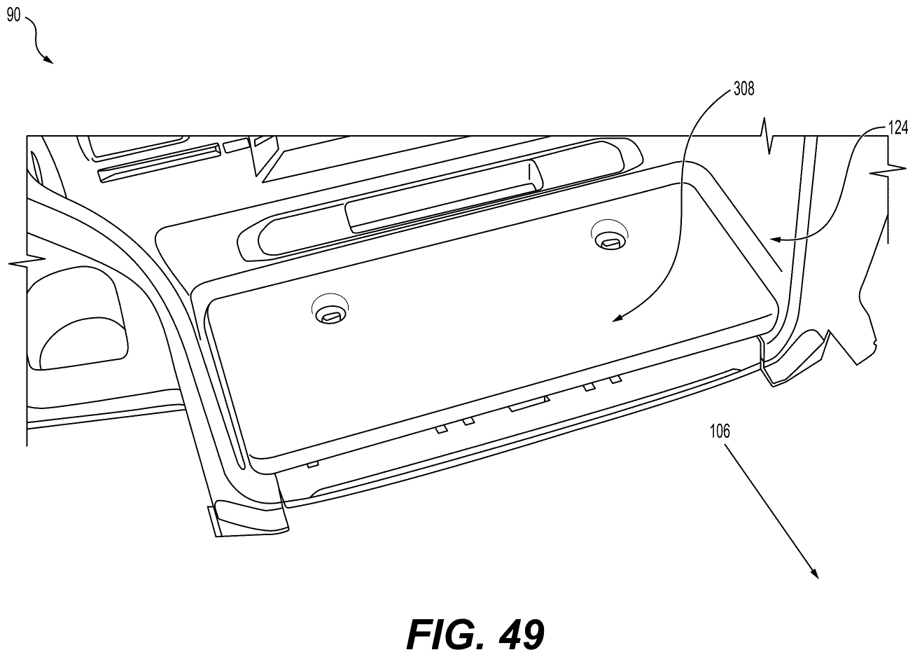

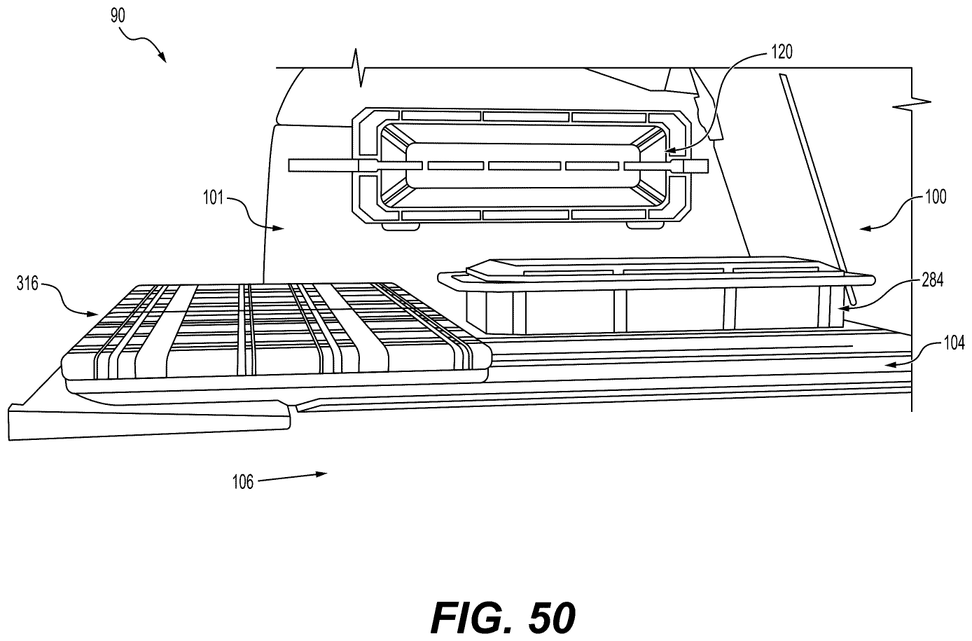

As shown in FIGS. 42-44, bags 324 of various sizes can be attached to the gear racks 120 to provide storage. FIG. 45-50 show various exemplary arrangements of bins 284 and cushion frames 308 attached to various gear rails 104 and gear racks 120.

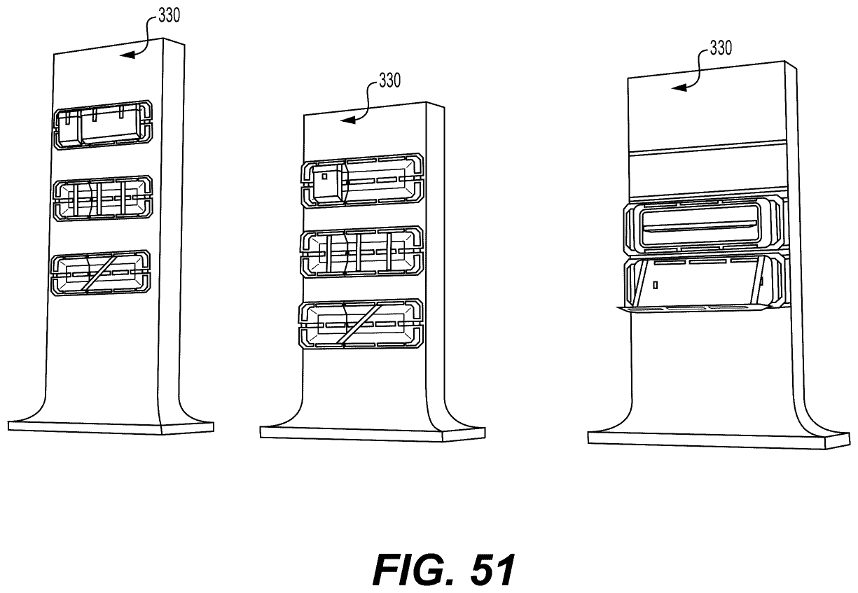

As shown in FIG. 51, the gear rack 120 can be mounted to storage walls 330 (e.g., a garage or shop wall) outside the vehicle 90. Additionally, locking pins 192 and/or gear rails 104 can be mounted on the storage walls 330 to allow accessories and/or gear racks 120 to be stored outside the vehicle 90. This allows various storage solutions to be loaded and unloaded from the vehicle 90 conveniently to meet the needs of the user.

### CONCLUSION

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

Certain terminology is used in the following description for convenience only and is not limiting. The words “right”, “left”, “lower”, and “upper” designate direction in the drawings to which reference is made. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

### EXAMPLES

### Example 1

An adaptive carry system comprising: a vehicle surface; a t-slot track recessed into the vehicle surface and extending along a track axis; a support channel recessed into the vehicle surface and extending parallel to the t-slot track; an accessory defining an accessory aperture configured to be aligned with the t-slot track, and the accessory including a projection sized to be received within the support channel; and a locking pin including a t-nut and a locking pin body, the t-nut sized to be received within the t-slot track and the locking pin body sized to engage the accessory aperture.

### Example 2

The adaptive carry system of example 1, wherein the vehicle surface is a rear floor of a cargo area.

### Example 3

The adaptive carry system of example 1, wherein the vehicle surface is a wall of a cargo area.

### Example 4

The adaptive carry system of example 1, wherein the vehicle surface is a frunk floor.

### Example 5

The adaptive carry system of example 4, wherein the frunk floor includes a recessed tub, a hinged lid, and a latch, and wherein the t-slot track and support channel are coupled to the hinged lid.

### Example 6

The adaptive carry system of example 1, wherein the vehicle surface is a cabin floor under a seat.

### Example 7

The adaptive carry system of example 1, wherein the support channel is a first support channel, and the adaptive carry system further comprises a second support channel recessed into the vehicle surface and extending parallel to the t-slot track, wherein the second support channel is positioned on an opposite side of the t-slot track from the first support channel.

### Example 8

The adaptive carry system of example 1, wherein the t-slot track is a first t-slot track, and the adaptive carry system further comprises a second t-slot track recessed into the vehicle surface and extending along a second track axis and spaced apart from the first t-slot track.

### Example 9

The adaptive carry system of example 8, wherein the accessory includes a second accessory aperture, the adaptive carry system further comprising a second locking pin including a second t-nut and a second locking pin body, the second t-nut sized to be received within the second t-slot track, and the second locking pin body sized to engage the second accessory aperture of the accessory.

### Example 10

The adaptive carry system of example 1, wherein the t-slot track extends parallel to a forward direction of a vehicle.

### Example 11

The adaptive carry system of example 1, wherein the t-slot track extends transverse to a forward direction of a vehicle.

### Example 12

The adaptive carry system of example 1, wherein the locking pin further includes a pin shaft and a locking pin handle, wherein the pin shaft is coupled to the t-nut, and wherein the locking pin handle is rotatably coupled to the locking pin body.

### Example 13

The adaptive carry system of example 12, wherein the locking pin body includes a central shank and two shoulders extending from the central shank.

### Example 14

The adaptive carry system of example 12, wherein the accessory is a gear rack defining a central dished cavity, a central aperture, and a perimeter aperture, wherein the central dished cavity is configured to receive a second accessory, and wherein at least one of the central aperture or the perimeter aperture is configured to receive the second accessory.

### Example 15

The adaptive carry system of example 14, wherein the gear rack includes a damper sized to receive the locking pin body and configured to inhibit vibration of the second accessory.

### Example 16

The adaptive carry system of example 15, wherein the perimeter aperture includes a plurality of apertures surrounding the central dished cavity.

### Example 17

The adaptive carry system of example 1, wherein the accessory includes a carry-on luggage including a handle, the handle defining the accessory aperture.

### Example 18

The adaptive carry system of example 17, wherein the accessory is sized to fit under a vehicle seat while coupled to the t-slot track.

### Example 19

The adaptive carry system of example 1, wherein the accessory includes a bin defining a tub and a lid including a second locking pin.

### Example 20

The adaptive carry system of example 19, wherein the accessory includes a second bin coupled to the bin via the second locking pin.

### Example 21

The adaptive carry system of example 19, wherein the lid is transparent or translucent.

### Example 22

The adaptive carry system of example 1, wherein the accessory includes a cushion frame defining the accessory aperture, and a cushion coupled to the cushion frame.

### Example 23

The adaptive carry system of example 22, wherein the accessory further includes a cushion cover that is removably coupled to the cushion frame.

### Example 24

The adaptive carry system of example 22, wherein the accessory further includes tie down straps extending from the cushion frame. Gear Racks

### Example 25

An adaptive carry system comprising: a gear rack including: a gear rack frame defining perimeter apertures, central apertures, a first locking assembly aperture, and a second locking assembly aperture; a first damper coupled to the first locking assembly aperture; a second damper coupled to the second locking assembly aperture; a first locking pin coupled to the first damper and movable between a first locked position and a first unlocked position; and a second locking pin coupled to the second damper and movable between a second locked position and a second unlocked position.

### Example 26

The adaptive carry system of example 25, wherein the gear rack frame defines an octagonal perimeter.

### Example 27

The adaptive carry system of example 25, wherein the perimeter apertures correspond in shape to a perimeter of the gear rack frame.

### Example 28

The adaptive carry system of example 25, wherein the gear rack frame further defines a clasp rim.

### Example 29

The adaptive carry system of example 25, wherein the gear rack is configured to be fastened to a vehicle surface via the first locking pin and the second locking pin.

### Example 30

The adaptive carry system of example 25, wherein the gear rack frame defines a dished cavity interior of the perimeter apertures.

### Example 31

The adaptive carry system of example 30, wherein the first damper and the second damper extend into the dished cavity.

### Example 32

The adaptive carry system of example 25, wherein the central apertures extend along a central plane of the gear rack frame.

### Example 33

The adaptive carry system of example 32, wherein the first locking pin and the second locking pin are arranged in the central plane.

### Example 34

The adaptive carry system of example 32, wherein the first damper and the second damper extend in the central plane.

### Example 35

The adaptive carry system of example 25, wherein the gear rack is configured to be mounted to a rear side of a passenger seat.

### Example 36

The adaptive carry system of example 25, wherein the gear rack is configured to be mounted within a vehicle cargo area.

### Example 37

The adaptive carry system of example 25, wherein the gear rack is configured to be mounted to a bottom side of a passenger seat.

### Example 38

The adaptive carry system of example 25, wherein the gear rack is configured to be mounted within a frunk of a vehicle.

### Example 39

The adaptive carry system of example 25, wherein the gear rack is configured to be mounted to a storage wall outside of a vehicle.

### Example 40

The adaptive carry system of example 25, further comprising: an accessory connected to the gear rack and including a first accessory aperture sized to receive the first locking pin and a second accessory aperture sized to receive the second locking pin to secure the accessory to the gear rack.

### Example 41

The adaptive carry system of example 25, further comprising: an accessory connected to the gear rack and including accessory support projections sized to be received within the perimeter apertures of the gear rack frame.

### Example 42

The adaptive carry system of example 25, further comprising: an accessory connected to the gear rack and including accessory clips sized to engage the perimeter apertures of the gear rack frame to secure the accessory to the gear rack.

### Example 43

The adaptive carry system of example 25, further comprising: an accessory connected to the gear rack and including a bag.

### Example 44

The adaptive carry system of example 43, wherein the accessory includes a second bag connected to the gear rack.

### Example 45

The adaptive carry system of example 25, further comprising: an accessory connected to the gear rack and including an elastic strap. Combined System

### Example 46

An adaptive carry system comprising: a gear rail including: a t-slot track recessed into a vehicle surface and extending along a track axis; and a support channel recessed into the vehicle surface and extending parallel to the t-slot track; a gear rack including: a gear rack frame supported on a second vehicle surface and defining at least one perimeter aperture and a locking assembly aperture; and a damper coupled to the locking assembly aperture; a first locking pin including a t-nut and a first locking pin body, the first t-nut sized to be received within the t-slot track of the gear rail; a second locking pin including a second locking pin body, the second locking pin coupled to the damper and the locking assembly aperture of the gear rack; a first accessory defining a first accessory aperture and including a projection, the first accessory aperture aligned with the t-slot track and the projection sized to be received within the support channel, the first accessory being fastenable to the gear rack by the first locking pin body; and a second accessory defining a second accessory aperture that is fastenable to the gear rack by the second locking pin.

### Example 47

The adaptive carry system of example 46, wherein the vehicle surface is a rear floor of a cargo area.

### Example 48

The adaptive carry system of example 46, wherein the vehicle surface is a wall of a cargo area.

### Example 49

The adaptive carry system of example 46, wherein the vehicle surface is a frunk floor.

### Example 50

The adaptive carry system of example 46, wherein the vehicle surface is a cabin floor under a seat.

### Example 51

The adaptive carry system of example 49, wherein the frunk floor defines a recessed tub and includes a hinged lid and a latch, and wherein the t-slot track and the support channel are coupled to the hinged lid.

### Example 52

The adaptive carry system of example 46, further comprising a second support channel recessed into the vehicle surface and extending parallel to the t-slot track, wherein the second support channel is disposed on an opposite side of the t-slot track from the support channel.

### Example 53

The adaptive carry system of example 46, further comprising a second t-slot track recessed into the vehicle surface and extending along a second track axis and spaced apart from the t-slot track.

### Example 54

The adaptive carry system of example 53, wherein the first accessory includes a third accessory aperture, the adaptive carry system further comprising a third locking pin including a second t-nut and a second locking pin boy, the t-nut sized to be received within the second t-slot track and the second locking pin body sized to engage the third accessory aperture of the first accessory.

### Example 55

The adaptive carry system of example 46, wherein the t-slot track extends parallel to a forward direction of a vehicle.

### Example 56

The adaptive carry system of example 46, wherein the t-slot track extends transverse to a forward direction of a vehicle.

### Example 57

The adaptive carry system of example 46, wherein the first locking pin further includes a pin shaft and a locking pin handle, the pin shaft coupled to the t-nut, and wherein the locking pin handle is rotatably coupled to the locking pin body.

### Example 58

The adaptive carry system of example 57, wherein the locking pin body includes a central shank and two shoulders extending from the central shank.

### Example 59

The adaptive carry system of example 57, wherein the first accessory is a second gear rack defining a central dished cavity, a central aperture, and a perimeter aperture, wherein the dished cavity is configured to receive a third accessory, and wherein at least one of the central aperture or the perimeter aperture is configured to engage the third accessory.

### Example 60

The adaptive carry system of example 59, wherein the gear rack includes a damper sized to receive the locking pin body and is configured to inhibit vibration of the third accessory.

### Example 61

The adaptive carry system of example 60, wherein the perimeter aperture includes a plurality of apertures surrounding the central dished cavity.

### Example 62

The adaptive carry system of example 46, wherein the first accessory includes a carry-on luggage including a handle, the handle including the first accessory aperture.

### Example 63

The adaptive carry system of example 62, wherein the first accessory is sized to fit under a vehicle seat while attached to the t-slot track.

### Example 64

The adaptive carry system of example 46, wherein the first accessory includes a bin defining a tub and a lid including a second locking pin.

### Example 65

The adaptive carry system of example 64, wherein the first accessory includes a second bin coupled to the bin via the second locking pin.

### Example 66

The adaptive carry system of example 64, wherein the lid is transparent or translucent.

### Example 67

The adaptive carry system of example 46, wherein the first accessory includes a cushion frame defining the accessory aperture, and a cushion coupled to the cushion frame.

### Example 68

The adaptive carry system of example 67, wherein the first accessory further includes a cushion cover that is removably coupled to the cushion frame.

### Example 69

The adaptive carry system of example 67, wherein the first accessory further includes tie down straps extending from the cushion frame.

### Example 70

The adaptive carry system of example 46, wherein the gear rack further defines a second locking assembly aperture, and the gear rack further comprises: a second damper coupled to the second locking assembly aperture; and a third locking pin coupled to the second damper and the second locking assembly aperture.

### Example 71

The adaptive carry system of example 70, wherein the gear rack frame defines an octagonal perimeter.

### Example 72

The adaptive carry system of example 70, wherein the perimeter apertures correspond in shape to a perimeter of the gear rack frame.

### Example 73

The adaptive carry system of example 70, wherein the gear rack frame further defines a clasp rim.

### Example 74

The adaptive carry system of example 70, wherein the gear rack is configured to be fastened to the vehicle surface via the second locking pin and the third locking pin.

### Example 75

The adaptive carry system of example 70, wherein the gear rack frame defines a dished cavity interior of the perimeter apertures.

### Example 76

The adaptive carry system of example 75, wherein the first damper and the second damper extend into the dished cavity.

### Example 77

The adaptive carry system of example 70, wherein the central apertures extend along a central plane of the gear rack frame.

### Example 78

The adaptive carry system of example 77, wherein the second locking pin and the third locking pin are arranged in the central plane.

### Example 79

The adaptive carry system of example 77, wherein the first damper and the second damper extend in the central plane.

### Example 80

The adaptive carry system of example 70, wherein the gear rack is configured to be mounted to a rear side of a passenger seat.

### Example 81

The adaptive carry system of example 70, wherein the gear rack is configured to be mounted within a vehicle cargo area.

### Example 82

The adaptive carry system of example 70, wherein the gear rack is configured to be mounted to a bottom side of a passenger seat.

### Example 83

The adaptive carry system of example 70, wherein the gear rack is configured to be mounted within a frunk of a vehicle.

### Example 84

The adaptive carry system of example 70, wherein the gear rack is configured to be mounted to a storage wall outside of a vehicle.

### Example 85

The adaptive carry system of example 70, wherein the second accessory includes accessory support projections sized to be received within the perimeter apertures of the gear rack frame.

### Example 86

The adaptive carry system of example 70, wherein the second accessory includes accessory clips sized to engage the perimeter apertures of the gear rack frame to secure the accessory to the gear rack.

### Example 87

The adaptive carry system of example 70, wherein the second accessory includes a bag.

### Example 88

The adaptive carry system of example 87, wherein the second accessory includes a second bag connected to the gear rack.

### Example 89

The adaptive carry system of example 88, wherein the second accessory includes an elastic strap.

What is claimed is:

1. An adaptive carry system comprising:
a gear rack including:
a gear rack frame defining perimeter apertures, central apertures, a first locking assembly aperture, and a second locking assembly aperture;
a first damper coupled to the first locking assembly aperture;
a second damper coupled to the second locking assembly aperture;
a first locking pin coupled to the first damper and movable between a first locked position and a first unlocked position; and
a second locking pin coupled to the second damper and movable between a second locked position and a second unlocked position.

2. The adaptive carry system of claim 1, wherein the gear rack frame defines an octagonal perimeter.

3. The adaptive carry system of claim 1, wherein the perimeter apertures correspond in shape to a perimeter of the gear rack frame.

4. The adaptive carry system of claim 1, wherein the gear rack frame further defines a clasp rim.

5. The adaptive carry system of claim 1, wherein the gear rack is configured to be fastened to a vehicle surface via the first locking pin and the second locking pin.

6. The adaptive carry system of claim 1, wherein the gear rack frame defines a dished cavity interior of the perimeter apertures.

7. The adaptive carry system of claim 6, wherein the first damper and the second damper extend into the dished cavity.

8. The adaptive carry system of claim 1, wherein the central apertures extend along a central plane of the gear rack frame,
wherein the first locking pin and the second locking pin are arranged in the central plane, and
wherein the first damper and the second damper extend in the central plane.

9. The adaptive carry system of claim 1, wherein the gear rack is configured to be mounted to:
a rear side of a passenger seat,
within a vehicle cargo area,
a bottom side of a passenger seat,
within a frunk, or
to a storage wall.

10. The adaptive carry system of claim 1, further comprising at least one of:
a first accessory connected to the gear rack and including a first accessory aperture sized to receive the first locking pin and a second accessory aperture sized to receive the second locking pin to secure the first accessory to the gear rack;
a second accessory connected to the gear rack and including accessory support projections sized to be received within the perimeter apertures of the gear rack frame;
a third accessory connected to the gear rack and including accessory clips sized to engage the perimeter apertures of the gear rack frame to secure the third accessory to the gear rack;
a fourth accessory connected to the gear rack and including a bag; or
a fifth accessory connected to the gear rack and including an elastic strap.

11. A vehicle comprising:
a vehicle surface; and
a gear rack removably coupled to the vehicle surface and including:
a gear rack frame defining perimeter apertures, central apertures, a first locking assembly aperture, and a second locking assembly aperture;
a first locking pin coupled to the first locking assembly aperture and movable between a first locked position and a first unlocked position; and
a second locking pin coupled to the second locking assembly aperture and movable between a second locked position and a second unlocked position.

12. The vehicle of claim 11, wherein the first locking pin is directly coupled to the vehicle surface, and
wherein the second locking pin is directly coupled to the vehicle surface.

13. The vehicle of claim 11, wherein the first locking pin rotates between the first locked position and the first unlocked position, and
wherein the second locking pin rotates between the second locked position and the second unlocked position.

14. The vehicle of claim 11, wherein the vehicle surface is a first vehicle surface, further comprising a second vehicle surface remote from the first vehicle surface, wherein the gear rack is removably coupled to the second vehicle surface.

15. The vehicle of claim 11, wherein the vehicle surface includes:
a rear side of a passenger seat,
a vehicle cargo area,
a bottom side of a passenger seat, or
a frunk.

16. The vehicle of claim 11, wherein the gear rack frame further defines a clasp rim.

17. The vehicle of claim 11, wherein the gear rack further includes:
a first damper coupled to the first locking assembly aperture and positioned between the first locking assembly aperture and the first locking pin; and
a second damper coupled to the second locking assembly aperture and positioned between the second locking assembly aperture and the second locking pin.

18. A vehicle comprising:
a first gear rack coupled to a frunk wall, the first gear rack including:
a first gear rack frame;
a first locking pin coupled to the first gear rack frame and movable between a first locked position and a first unlocked position; and
a second locking pin coupled to the first gear rack frame and movable between a second locked position and a second unlocked position,
wherein the first gear rack frame is configured to support an accessory; and
a second gear rack coupled to a rear cargo area wall, the second gear rack including:
a second gear rack frame;
a third locking pin coupled to the second gear rack frame and movable between a third locked position and a third unlocked position; and
a fourth locking pin coupled to the second gear rack frame and movable between a fourth locked position and a fourth unlocked position,
wherein the second gear rack frame is configured to support the accessory.

19. The vehicle of claim 18, wherein the first gear rack further includes a support bracket extending from the first gear rack frame and configured to support the accessory.

20. The vehicle of claim 18, wherein the first gear rack frame and the second gear rack frame are removable from the vehicle.
